(19) United States
(12) Patent Application Publication
(10) Pub. No.: US 2025/0239416 A1
(43) Pub. Date: Jul. 24, 2025

(54) PHYTO-MEDIATED SYNTHESIS OF ZnO/CuO NANOCOMPOSITES FOR DUAL-MODE SUPERCAPACITOR DEVICES

(71) Applicant: PRINCESS NOURAH BINT ABDULRAHMAN UNIVERSITY, Riyadh (SA)

(72) Inventors: Rushikesh G. BOBADE, Khopoli (IN); Thamraa ALSHAHRANI, Riyadh (SA); Bidhan PANDIT, London (GB); Akhil Pradiprao KHEDULKAR, Hsinchu (TW); Revanappa C. AMBARE, Khopoli (IN); Anuj KUMAR, Mathura (IN); Mohd UBAIDULLAH, Riyadh (SA); Abdullah M. AL-ENIZI, Riyadh (IN); Mohd. SHKIR, Abha (SA); Yufeng ZHO, Shanghai (CN)

(73) Assignee: PRINCESS NOURAH BINT ABDULRAHMAN UNIVERSITY, Riyadh (SA)

(21) Appl. No.: 19/172,221

(22) Filed: Apr. 7, 2025

(51) Int. Cl. H01G 11/46; C01G 3/02; C01G 9/02; H01G 11/34; H01G 11/52; H01G 11/56; H01G 11/86; H01G 13/04

(52) U.S. Cl. CPC H01G 11/46; C01G 3/02; C01G 9/02; H01G 11/34; H01G 11/52; H01G 11/56; H01G 11/86; H01G 13/04; C01P 2002/72; C01P 2002/82; C01P 2002/85; C01P 2004/03; C01P 2006/40

(57) ABSTRACT

The method for synthesizing ZnO//CuO nanocomposites for dual-mode supercapacitor devices. The method comprises preparing a precursor solution by dissolving Zn(NO₃)₂·6H₂O and Cu(NO₃)₂·3H₂O in 100 milliliters of sterile double-distilled water; separately adding 5 milliliters of a plant extract and the 50 milliliters of precursor solution dropwise into a reaction flask under stirring at 100-120 rpm to form a mixture and a precipitate; centrifuging the mixture to separate the precipitate from the supernatant; drying the separated precipitate in a hot air oven at approximately 323 K until fully dehydrated; calcining the dried precipitate to obtain the ZnO//CuO nanocomposite and fabricating a symmetric supercapacitor device using ZnO//CuO nanocomposite electrodes, a filter paper separator and PVA-KOH gel electrolyte and an asymmetric supercapacitor device using an activated carbon electrode, a ZnO//CuO nanocomposite electrode, a filter paper separator and PVA-KOH gel electrolyte that exhibits a Cs of 819.4 F/g at a sweep rate of 2 mV/s.

### TECHNICAL FIELD

The present disclosure relates to the field of nanomaterials and energy storage devices, specifically to the phyto-mediated method for synthesizing zinc oxide-copper oxide (ZnO//CuO) nanocomposites. The invention focuses on the preparation of ZnO//CuO nanocomposites using plant extracts, aimed at enhancing the performance of dual-mode supercapacitor devices. More particularly, the invention provides a sustainable and eco-friendly method for synthesizing ZnO//CuO nanocomposites, leveraging plant-derived reducing agents and stabilizers for the efficient fabrication of electrodes in supercapacitors.

### BACKGROUND

The growing demand for efficient and sustainable energy storage solutions have led to a widespread development of supercapacitors, which offer higher power density, quick charge-discharge rates, as well long operational lifetimes. The electrode material is a critical component that directly influences the electrochemical performance of these devices. Traditional fabrication methods for electrode materials often involve the use of hazardous chemicals and energy-intensive processes, which are increasingly seen as unsustainable in the context of global environmental concerns. To address these issues, green synthesis approaches have been explored, leveraging natural resources and eco-friendly processes to produce high-performance nanomaterials.

The development of supercapacitors has witnessed significant advancements with a focus on enhancing energy and power densities while maintaining long-term stability and environmental sustainability. Symmetric supercapacitors, which utilize identical electrodes made from materials like activated carbon or metal oxides, offer straightforward construction and operational simplicity. However, these devices often face limitations in energy density due to a restricted charge storing capacity of carbon-based materials and the inherent properties of metal oxides. Conversely, asymmetric supercapacitors employ different materials for the positive and negative electrodes, combining carbon-based material with transition metal oxides or conducting polymers. This design aims to leverage both electric double-layer capacitance and pseudocapacitance, thereby achieving a higher voltage window and improved energy density. Despite these advantages, achieving an optimal balance between the different electrode materials remains challenging, and many current methods involve complex, costly, or environmentally unfriendly synthesis processes.

Recent research and patents have explored synthesis methods for ZnO//CuO nanocomposites, aiming to enhance supercapacitor performance. Traditional synthesis techniques, such as sol-gel methods and hydrothermal processes, often require high temperatures or toxic chemicals, raising concerns about sustainability and scalability. Green synthesis approaches using plant extracts have emerged as a more environmentally benign alternative, offering reduced costs and simplified procedures. Specifically, Moringa Oleifera extract has been recognized for its potential in synthesizing nanomaterials, yet its application in producing ZnO//CuO nanocomposites for supercapacitors has been minimally explored. The present invention addresses these gaps by utilizing a green synthesis approach with Moringa Oleifera extract to produce a ZnO//CuO nanocomposite at an optimized temperature of 623 K, effectively bridging the performance and sustainability gaps in both symmetric and asymmetric supercapacitor applications. This innovation not only simplifies the synthesis process but also enhances material properties, providing a more efficient and sustainable solution for energy storage technologies.

In view of the foregoing discussion, it is portrayed that there is a need to have a green synthesis approach to create ZnO//CuO nanocomposites with superior electrochemical properties, effectively enhancing the performance and sustainability of both symmetric and asymmetric supercapacitor devices. The resulting material provides a practical solution to the pressing need for energy storage systems that meet both performance and environmental standards.

### BRIEF SUMMARY

The present disclosure seeks to provide novel ZnO//CuO composite nanomaterial synthesized using a green approach that utilizes Moringa Oleifera plant extract as a bio reductant and stabilizing agent. This synthesis is optimized at a specific temperature of 623 K, a critical condition under which the ZnO//CuO nanocomposite phase is effectively formed. The resulting material exhibits exceptional electrochemical properties, making it suitable for use as electrode in both symmetric as well asymmetric supercapacitor devices. An unique aspect of this invention is the utilization of same ZnO//CuO nanocomposite electrode in both device configurations, a feature that enhances its versatility and applicability in diverse energy storage systems.

In asymmetric supercapacitor applications, the ZnO//CuO nanocomposite electrode exhibits remarkable electrochemical stability and performance, driven by the complementary interactions between the ZnO and CuO phases at the nanoscale. This composite electrode is particularly effective in enhancing energy density, as the distinct electrochemical properties of ZnO and CuO contribute to a broader operational voltage window and improved charge storage efficiency. The robust architecture of the ZnO//CuO nanocomposite ensures sustained performance over prolonged cycling, with minimal degradation in capacitance, even under high current densities. This stability is crucial for maintaining the overall efficiency and longevity of asymmetric supercapacitors, where the electrode must consistently perform under varying operational conditions. The use of a single ZnO//CuO nanocomposite electrode in the asymmetric configuration not only simplifies the device design but also optimizes material utilization, reducing costs while delivering higher energy density as well reliable long-term durability. In symmetric supercapacitors, the same electrode material facilitates the achievement of higher energy density, which is a result of the complementary electrochemical behavior of the ZnO and CuO components. This dual functionality not only simplifies the design and fabrication process but also reduces material costs and enhances the overall efficiency of the supercapacitor devices.

The ability to employ a single electrode material in both symmetric and asymmetric configurations without compromising performance metrics such as specific capacitance, energy density, as well power density represents a significant advancement in supercapacitor technology. This invention not only contributes to the field of sustainable nanomaterial synthesis but also offers a practical and scalable solution for a next cohort of energy storing devices, where environmental sustainability and high performance are paramount.

Yet, in a further embodiment, an asymmetric supercapacitor device is disclosed. The device includes a first electrode comprising activated carbon (AC), wherein the first electrode is a positive electrode.

The device further includes a second electrode comprising a ZnO//CuO nanocomposite, wherein the second electrode is a negative electrode.

The device further includes a separator interposed between the first and second electrodes, wherein the separator is filter paper.

The device further includes a PVA-KOH gel electrolyte in contact with the first and second electrodes and the separator, wherein at least a portion of the first and second electrodes are coated with the PVA-KOH gel electrolyte that has been dried, wherein the first and second electrodes are coated with the PVA-KOH gel electrolyte that has been dried at a temperature between about 303 K and about 308 K, wherein the first and second electrodes are pressed together for about 1 hour.

An object of the present disclosure is to provide a novel ZnO//CuO composite nanomaterial synthesized using a green, phyto-mediated approach, utilizing Moringa oleifera plant extract as a bio-reductant and stabilizing agent.

Another object of the present disclosure is to establish an optimized synthesis method for the ZnO//CuO nanocomposite, specifically at a calcination temperature of 623 K, to ensure effective formation of the desired nanocomposite phase.

Another object of the present disclosure is to develop a single ZnO//CuO nanocomposite electrode material suitable for use in both symmetric and asymmetric supercapacitor device configurations, thereby enhancing versatility and simplifying device design.

Another object of the present disclosure is to simplify the design and fabrication process of both symmetric and asymmetric supercapacitors by utilizing a single electrode material, thereby reducing material costs and improving overall device efficiency.

Another object of the present disclosure is to provide a sustainable, eco-friendly, and scalable solution for the next generation of energy storage devices, combining high performance with environmental consciousness.

Another object of the present disclosure is to achieve improved electrochemical properties in the resulting supercapacitor devices, including enhanced specific capacitance, energy density, and power density.

Yet another object of the present invention is to deliver an expeditious and cost-effective asymmetric supercapacitor device and symmetric supercapacitor device.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1(a) illustrates the XRD of ZnO//CuO nanocomposite thin film in accordance with an embodiment of the present disclosure;

FIG. 1(b) illustrates the FTIR of ZnO//CuO nanocomposite thin film in accordance with an embodiment of the present disclosure;

FIG. 1(c) illustrates the ramman spectrum of ZnO//CuO nanocomposite thin film in accordance with an embodiment of the present disclosure;

FIG. 1(d) illustrates the FE-SEM of ZnO//CuO nanocomposite thin film in accordance with an embodiment of the present disclosure;

FIG. 2(a) illustrates the XPS survey spectrum, resolution spectrum of ZnO//CuO nanocomposite in accordance with an embodiment of the present disclosure;

FIG. 2(b) illustrates the XPS survey spectrum, resolution spectrum in accordance with an embodiment of the present disclosure;

FIG. 2(c) illustrates the XPS survey spectrum, resolution spectrum of Cu 2p in accordance with an embodiment of the present disclosure;

FIG. 2(d) illustrates the XPS survey spectrum, resolution spectrum of O 1s in accordance with an embodiment of the present disclosure;

FIG. 3(a) illustrates the CV plot at different sweep rate of ZnO//CuO nanocomposite electrode in accordance with an embodiment of the present disclosure;

FIG. 3(b) illustrates Cs in F/g vs sweep rate in mV/s of ZnO//CuO nanocomposite electrode in accordance with an embodiment of the present disclosure;

FIG. 3(c) illustrates the GCD plot at dissimilar current density in mA/cm² of ZnO//CuO nanocomposite electrode in accordance with an embodiment of the present disclosure;

FIG. 3(d) illustrates regon plot of Cs vs current density of ZnO//CuO nanocomposite electrode in accordance with an embodiment of the present disclosure;

FIG. 3(e) illustrates stability plot;

FIG. 3(f) and the Nyquist plot with matching circuit of ZnO//CuO nanocomposite electrode in accordance with an embodiment of the present disclosure;

FIG. 4(a) illustrates the CV plot at different sweep rate from 5-100 mV/s of symmetric solid-state device (ZnO//CuO@ZnO//CuO) in accordance with an embodiment of the present disclosure;

FIG. 4(b) illustrates the Cs in mF/g vs sweep rate in mV/s of symmetric solid-state device (ZnO//CuO@ZnO//CuO) in accordance with an embodiment of the present disclosure;

FIG. 4(c) illustrates the GCD plot from 10-14 current density in mA/cm² of symmetric solid-state device (ZnO//CuO@ZnO//CuO) in accordance with an embodiment of the present disclosure;

FIG. 4 (d) illustrates the regon plot of Cs vs current density of symmetric solid-state device (ZnO//CuO@ZnO//CuO) in accordance with an embodiment of the present disclosure;

FIG. 4 (e) illustrates the regon graph of SE in Wh/kg vs SP in W/kg of symmetric solid-state device (ZnO//CuO@ZnO//CuO) in accordance with an embodiment of the present disclosure;

FIG. 4(f) illustrates the the Nyquist plot of symmetric solid-state device (ZnO//CuO@ZnO//CuO) in accordance with an embodiment of the present disclosure;

FIG. 5(a) illustrates the CV plot at different sweep rates from 5-100 mV/s of the asymmetric solid-state device (ZnO//CuO@AC) in accordance with an embodiment of the present disclosure;

FIG. 5(b) illustrates the Cs in mF/g vs sweep rate in mV/s of the asymmetric solid-state device (ZnO//CuO@AC) in accordance with an embodiment of the present disclosure;

FIG. 5(c) illustrates the GCD plot from 10-14 current density in mA/cm² of the asymmetric solid-state device (ZnO//CuO@AC) in accordance with an embodiment of the present disclosure;

FIG. 5(d) illustrates the regon plot of Cs vs current density of the asymmetric solid-state device (ZnO//CuO@AC) in accordance with an embodiment of the present disclosure;

FIG. 5(e) illustrates the regon plot of SE in Wh/kg vs SP in W/kg of the asymmetric solid-state device (ZnO//CuO@AC) in accordance with an embodiment of the present disclosure;

FIG. 5(f) illustrates the stability plot of the asymmetric solid-state device (ZnO//CuO@AC) in accordance with an embodiment of the present disclosure;

FIG. 5(g) illustrates the Nyquist plot of the asymmetric solid-state device (ZnO//CuO@AC) in accordance with an embodiment of the present disclosure;

FIG. 5(h) illustrates the actual photograph of the device with a glowing green LED light using the asymmetric solid-state device (ZnO//CuO@AC) in accordance with an embodiment of the present disclosure;

FIG. 6 illustrates a flow chart of a method for synthesizing ZnO//CuO nanocomposites for dual-mode supercapacitor devices in accordance with an embodiment of the present disclosure;

FIG. 7 illustrates a block diagram of a symmetric supercapacitor device in accordance with an embodiment of the present disclosure; and

FIG. 8 illustrates a block diagram of an asymmetric supercapacitor device in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs.

The system, methods, and examples provided herein are illustrative only and not intended to be limiting.

Embodiments of the present disclosure will be described below in detail concerning the accompanying drawings.

### Synthesis of ZnO//CuO Nanocomposite Thin Film

### Materials

The Zinc nitrate hexahydrate (Zn(NO₃)₂·6H₂O) (96% extra pure), copper nitrate trihydrate (Cu(NO₃)₂·3H₂O) (99.5% extra pure), Potassium hydroxide (KOH), acetone, and polyvinyl alcohol (PVA). All chemicals were acquired from Merck Private Ltd and used without using extra purification. SS was used as a conducting substrate.

### Synthesis of Plant Extract

To prepare the Moringa oleifera extract, fresh leaves cleaned using sterile double-distilled water (DDW) to remove any soil or impurities. After cleaning, the leaves were shade-dried for 6-7 days to preserve the active metabolites. The dried leaves were then finely ground into a powder and stored in an airtight container to prevent moisture absorption. To create the aqueous extract, 5 grams of the powdered leaves were combined with 50 milliliters of distilled water, thoroughly mixed, and heated at 353 K for 30 minutes. After heating, a mixture has permissible to cool to room temperature, then filtered, and a resulting extract has stored in sterile containers at 277 K for future use.

### Method of ZnO//CuO Nanocomposite

For this study, Zn(NO₃)₂·6H₂O and Cu(NO₃)₂·3H₂O were used as metal precursors. A precursor solution with a concentration of 1 M was prepared by dissolving the compounds in 100 milliliters of sterile DDW. To synthesize ZnO//CuO nanocomposites, 50 milliliters of the precursor solution and 5 milliliters of plant extract were separately added dropwise into reaction flasks while stirring at 100-120 rpm. An adding of the extract resulted in a creation of a fine precipitate. A mixture has then subjected to centrifugation at 8000 rpm for 20 minutes to separate a precipitate from a supernatant. A collected precipitate has dried in a hot air oven nearly 323 K until fully dehydrated. Subsequently, the dried material has calcined at 623 K for 1 hour and kept in vials for further characterization as well application studies.

### Synthesis of PVA-KOH Electrolyte

To make an alkaline gel polymer electrolyte separator, a total of 4 grams of KOH and 3 grams of polyvinyl alcohol (PVA) were used. Initially, 3 grams of PVA were dissolved in 40 milliliters of DDW. This mixture was heated between 348 K to 353 K while continuously stirring until a clear, thick solution formed. After cooling to room temperature, 10 milliliters of a 1 M KOH solution have added, and a mixture has stirred for 6 to 7 hours to ensure thorough blending. The resulting transparent and adhesive solution was then poured into a Petri dish and left to air dry at room temperature, forming an alkaline gel polymer electrolyte separator. This separator was subsequently used in the assembly of solid-state supercapacitor devices, including a symmetric ZnO//CuO@ZnO//CuO device and an asymmetric ZnO//CuO@AC device.

### Synthesis of Activated Carbon (AC) Electrode

A polyvinyl alcohol (PVA) solution has prepared through dissolving 1 gram of PVA in 10 milliliters of distilled water (DW). This mixture was heated and stirred continuously at a temperature of 343-353 K for 2 to 3 hours until fully dissolved. Subsequently, activated carbon (AC) has adding to the PVA solution, and a mixture has stirred for additional 2 hours at the same temperature range. A resulting PVA-AC mixture has dried in desiccator, creating a uniform slurry. This slurry was then spread onto a pre-cleaned stainless steel (SS) substrate using a doctor blade, measuring approximately 15 cm by 20 cm, to form an electrode. An electrode samples have initially drying at room temperature (343-353 K) for 4 hours and then further heat-treated in a muffle furnace at 353 K for 6 to 7 hours to complete the process.

### Fabrication of Symmetric Devices

The ZnO//CuO nanocomposite electrodes have employed as a positive and negative electrodes, respectively. A filter paper has used as a separator among two electrodes, and a PVA-KOH gel has utilized as the electrolyte. The electrodes as well the separator paper have immersed in a gel electrolyte for 10-15 seconds and then air-dried at 303 K for 1 hour. Before assembling the device, the thin film electrodes were coated with the PVA-KOH gel as well allowable to dry in electric oven at temperatures ranging from 303 K to 308 K for 6 to 8 hours to eliminate any adsorbed water on the surface. To enhance the electrolyte-electrode interface, an asymmetric device was subsequently assembled by pressing the coated region of the electrodes for 1 hour.

### Fabrication of Asymmetric Devices

Activated carbon (AC) and ZnO//CuO nanocomposite electrodes have utilized as a positive as well negative electrode, correspondingly. A filter paper has used to distinct 2 electrodes, with a PVA-KOH gel serving as the electrolyte. The electrodes and the separator paper have deep in a gel electrolyte for 10 seconds, followed by air drying at 303 K for 1 hour. Prior to device assembly, the thin film electrodes were coated with PVA-KOH gel and dried in an electric oven at temperatures between 303 K and 308 K for 6 to 8 hours to ensure the removal of any adsorbed water. To optimize an electrolyte-electrode interface, an coated area of an electrodes has compressed for 1 hour during an final assembly of an asymmetric device.

### Physical Measurements

### Experiment Procedures for Supercapacitors Properties Measurements.

The electrochemical characteristics of ZnO//CuO nanocomposite thin films were investigated using cyclic voltammetry (CV), galvanostatic charge-discharge (GCD), and electrochemical impedance spectroscopy (EIS). The evaluation was conducted in a three-electrode configuration within a 1 M KOH electrolyte. In this setup, a flexible ZnO//CuO nanocomposite thin films served as a working electrode, though a platinum electrode and an Ag/AgCl electrode have used as a counter as well reference electrodes, correspondingly. CV measurements have agreed out at varying sweep rates within a potential window ranging from −1.48 to 0.19 V. GCD analysis have achieved at dissimilar current densities within the same potential range. For EIS analysis, an AC amplitude of 10 mV has applied at a bias potential of 0.4 V, with a frequency ranging spanning from 1 Hz to 100 kHz.

$$C {s}_{( C V )} = \frac{1}{m v ( {v}_{f} - {v}_{i} )} {\int }_{{v}_{i}}^{{v}_{f}} I ( V ) dv \qquad ( 1 )$$

$$C {s}_{( G C D )} = \frac{I Δ t}{m ( {v}_{f} - {v}_{i} )} \qquad ( 2 )$$

$$SE = \frac{0.5 \times C {s}_{( G C D )} \times {( {v}_{f} - {v}_{i} )}^{2}}{3.6} \qquad ( 3 )$$

$$SP = \frac{3600 \times S E}{Δ t} \qquad ( 4 )$$

Where, “Cs_{(CV)}” specific capacitance in F/g using CV plots, “(V_{f}−Vᵢ)” potential window, ‘m’ active mass on electrode, ‘v’ sweep rate in mV/s, “∫ᵥ_{ᵢ}^{v}^{_{f}}” integral area under of CV plots, “SE” specific energy in Wh/kg, “SP” specific power in W/kg, “V” applied voltage in volt, “I (V)” current in mA, “Δt” (t) a time taken for discharge and “I (A)” specifies a current at which discharge has accomplished, CS_{(GCD)} (F/g) signifies the specific capacitance using GCD plots, (V_{f}−Vᵢ) (V) signifies a potential window.

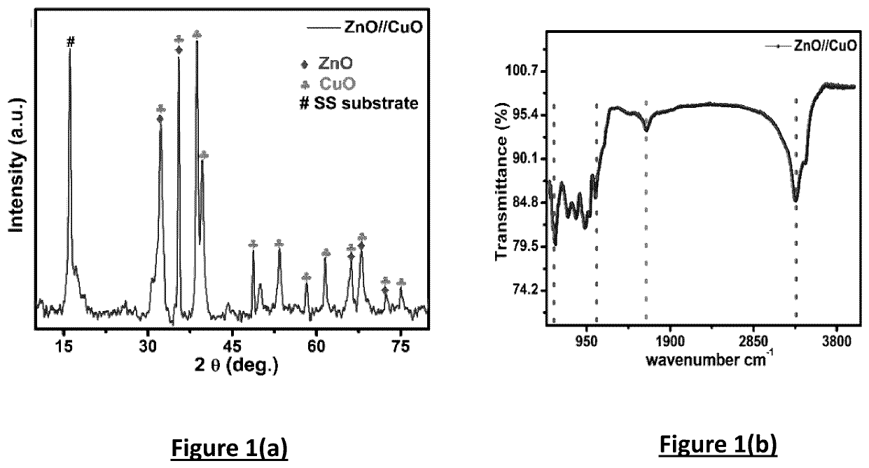

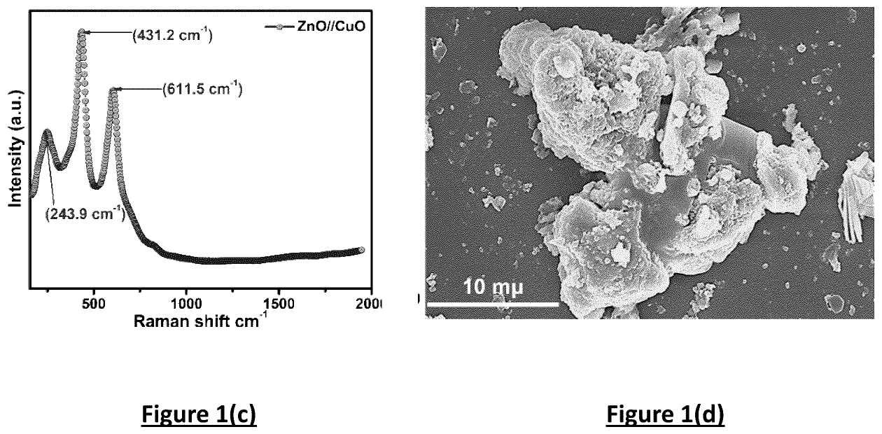

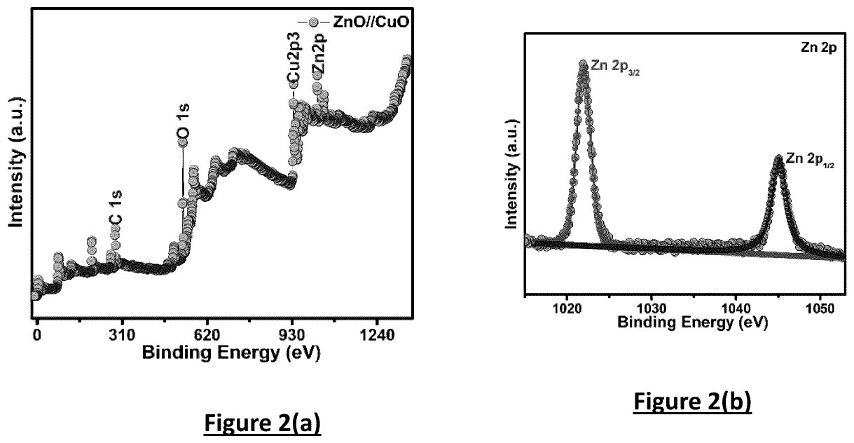

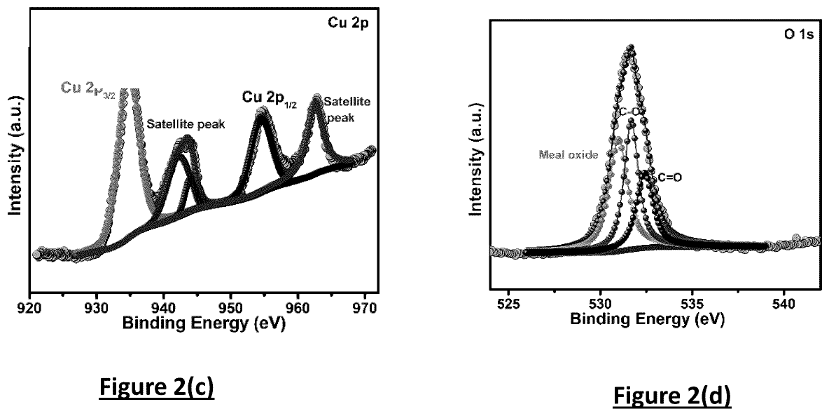

FIG. 1(a) illustrates the XRD of ZnO//CuO nanocomposite thin film in accordance with an embodiment of the present disclosure;

FIG. 1(b) illustrates the FTIR of ZnO//CuO nanocomposite thin film in accordance with an embodiment of the present disclosure;

FIG. 1(c) illustrates the ramman spectrum of ZnO//CuO nanocomposite thin film in accordance with an embodiment of the present disclosure;

FIG. 1(d) illustrates the FE-SEM of ZnO//CuO nanocomposite thin film in accordance with an embodiment of the present disclosure;

FIG. 1 (a-d) illustrates (a) XRD, (b) FTIR, (c) Ramman spectrum, (d) the FE-SEM of ZnO//CuO nanocomposite thin film in accordance with an embodiment of the present disclosure.

### XRD Analysis

The XRD patterns and associated crystal structures of ZnO//CuO nanocomposite synthesized using green synthesis are demonstrated in FIG. 1(a). The XRD pattern in FIG. 1(a) displays distinct peaks that correspond to ZnO, CuO, and the stainless steel (SS) substrate. The ZnO peaks are consistent with the JCPDS card number 36-1451, confirming its hexagonal wurtzite structure. Meanwhile, the CuO peaks match the JCPDS card number 48-1548, indicating a monoclinic structure. The prominent peaks observed at 2θ angles of 32.3°, 35.2°, 66.1°, 68.2°, and 72.4° correspond to a (100), (101), (200), (112) and (004) planes of ZnO, correspondingly. Additionally, a peak at 32.3°, 35.2°, 38.6°, 39.9°, 48.6°, 53.3°, 58.2°, 61.7°, 66.1°, 68.2°, 72.4°, and 75.3° are attributed to the (110), (11-1), (111), (200), (20-2), (020), (202), (11-3), (022), (220), (311) and (22-2) planes of CuO. The presence of these peaks recommends a successful integration of Cu within a ZnO, resulting in a creation of a ZnO//CuO nanocomposite. The average crystallite size (D) is assessed to be approximately 15-20 nm, calculated using Scherrer's formula.

### FTIR Analysis

The FTIR spectrum of the ZnO//CuO nanocomposite manufactured using green synthesis is presented in FIG. 1(b). This spectrum reveals several distinctive peaks that indicate the presence of various functional groups and metal-oxide bonds within the composite. A wide absorption band at 3331.31 cm⁻¹ is observed, attributed to O—H stretching vibrations of hydroxyl groups, which may originate from water molecules adsorbed on the surface or hydroxyl groups from the Moringa oleifera extract. A peak at 1634.75 cm⁻¹ matches to a bending vibrations of water molecules, suggesting an occurrence of moisture in a sample. Peaks at 1048.20 cm⁻¹ as well 984.86 cm⁻¹ have allotted to C—O stretching vibrations, indicating an occurrence of organic compounds from the Moringa oleifera extract. Additionally, peaks at 927.43 cm⁻¹, 826.35 cm⁻¹, and 594.95 cm⁻¹ are related to metal-oxygen (M-O) stretching vibrations. Specifically, the peak at 594.95 cm⁻¹ is attributed to Cu—O bonds in CuO, while a peak at 532.98 cm⁻¹ parallels to Zn—O bonds in ZnO. Small peaks in the 500-600 cm⁻¹ range, such as those at 563.66 cm⁻¹ and 538.93 cm⁻¹, further support the presence of ZnO and CuO in a composite. These observations confirm a successful incorporation of copper into a zinc oxide matrix, forming the ZnO//CuO nanocomposite. The FTIR analysis also highlights the role of Moringa oleifera leaves in the synthesis, potentially contributing organic residues to the final composite.

### Raman Spectrum Analysis

The Raman spectrum of a ZnO//CuO nanocomposite, exposed in FIG. 1(c), displays distinct vibrational modes associated with both ZnO and CuO, confirming the successful integration of copper into the ZnO structure. Prominent peaks at approximately 243.9 cm⁻¹, 431.2 cm⁻¹, and 611.5 cm⁻¹ correspond to the E2 (high) mode, A1 (TO) (Transverse Optical) mode, and A1 (LO) (Longitudinal Optical) mode of ZnO, respectively, aligning well with established ZnO vibrational modes in the literature. The observed broadening and slight shifts in these Raman peaks suggest that an incorporation of copper ions into a ZnO lattice induces local distortions and creates additional defect states. Notably, the characteristic peaks of CuO, typically found around 300 cm⁻¹ and 620 cm⁻¹, are not prominently observed, indicating that copper is either well-distributed within the ZnO matrix or exists in a highly disordered form. Additionally, a broad peak observed in a range of 1100-1400 cm⁻¹ may be attributed to second-order Raman scattering or contributions from defect-related modes, further confirming the composite nature and defect characteristics of the material.

### FE-SEM Analysis

The FIG. 1 (d) presents FE-SEM images of the ZnO//CuO nanocomposite, showcasing its complex coral-like porous structure. At a 10 μm magnification, the micrographs reveal a detailed network of interconnected particles that form an extensively porous and absorbent framework. The images also highlight the granular texture of the material, with a consistent distribution and clearly defined boundaries of the aggregates.

FIG. 2(a) illustrates the XPS survey spectrum, resolution spectrum of ZnO//CuO nanocomposite in accordance with an embodiment of the present disclosure;

FIG. 2(b) illustrates the XPS survey spectrum, resolution spectrum in accordance with an embodiment of the present disclosure;

FIG. 2(c) illustrates the XPS survey spectrum, resolution spectrum of Cu 2p in accordance with an embodiment of the present disclosure;

FIG. 2(d) illustrates the XPS survey spectrum, resolution spectrum of O 1s in accordance with an embodiment of the present disclosure;

FIG. 2 (a-d) illustrates The XPS survey spectrum, resolution spectrum of (a) ZnO//CuO nanocomposite (b) Zn 2p, (c) Cu 2p, and (d) O 1s in accordance with an embodiment of the present disclosure.

### XPS Analysis

The XPS has employed to investigate an elemental composition as well chemical states of a synthesized ZnO//CuO nanocomposite electrode. A survey spectrum (see FIG. 2(a)) indicates a presence of Zn, Cu, O, and C elements within the nanocomposite, with distinct peaks corresponding to Zn 2p, Cu 2p, O 1s, and C 1s. In a deconvoluted Zn 2p spectrum (FIG. 2(b)), two significant peaks are observed at 1021.8 eV as well 1044.9 eV, which are assigned to Zn 2p3/2 and Zn 2p1/2, correspondingly, with a spin-orbit splitting of 23.2 eV. This observed splitting is in line with the presence of zinc in the ZnO matrix, thereby verifying the successful integration of zinc oxide into the nanocomposite. A Cu 2p spectrum (FIG. 2(c)) demonstrations peaks at 932.6 eV and 952.2 eV, which are attributed to Cu 2p3/2 and Cu 2p1/2, respectively. Additionally, satellite peaks detected at approximately 942.6 eV and 962.8 eV indicate the presence of Cu2+ states, typical of copper oxide (CuO). The energy difference of 19.6 eV among the Cu 2p3/2 and Cu 2p1/2 peaks confirms a presence of CuO within the composite. This information is significant as the Cu2+ states contribute to the pseudocapacitive properties of a material, thereby improving its electrochemical recital. The O 1s spectrum (FIG. 2(d)) reveals three separate peaks at around 529.8 eV, 531.3 eV, and 532.6 eV. These peaks are associated with metal-oxide bonds (O-M), oxygen in hydroxyl groups (O—H), and adsorbed molecular water or carbonates, respectively. The peak at 529.8 eV is the most prominent, indicating a significant presence of lattice oxygen and confirmatory the formation of a metal oxides ZnO and CuO.

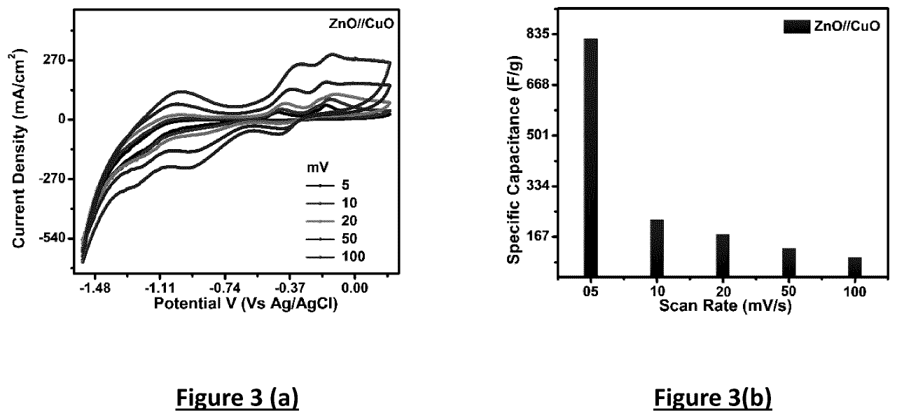

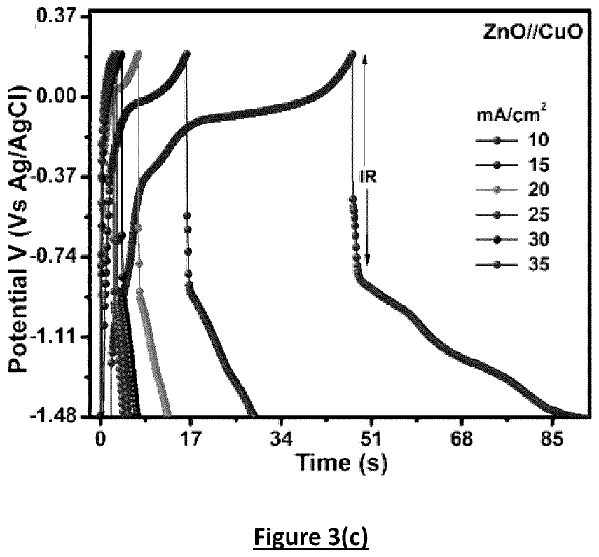

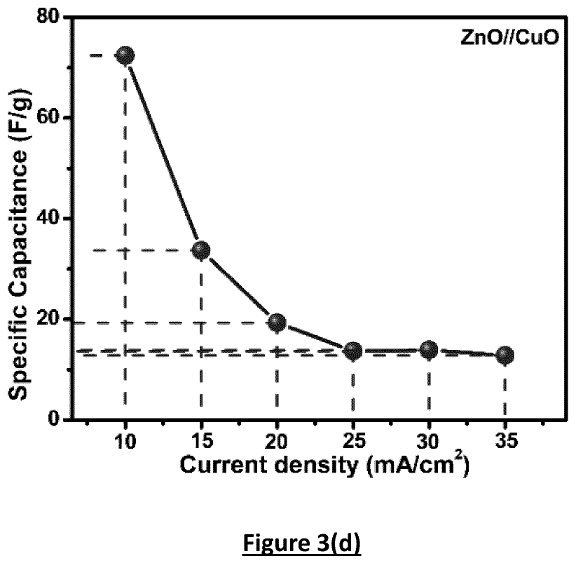

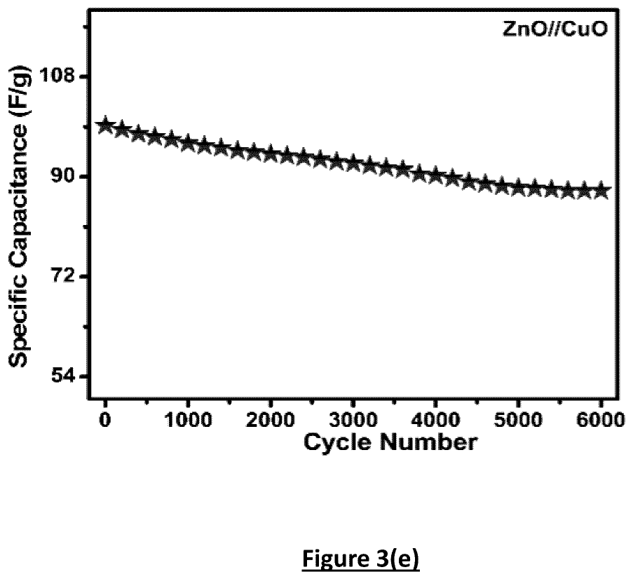

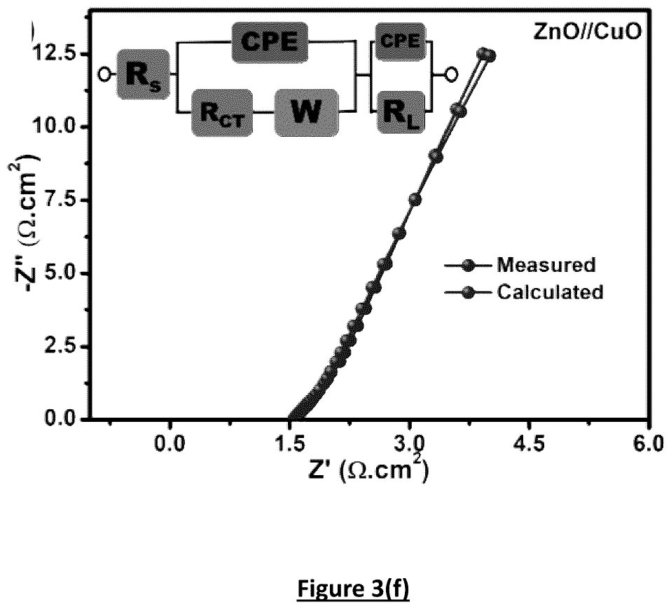

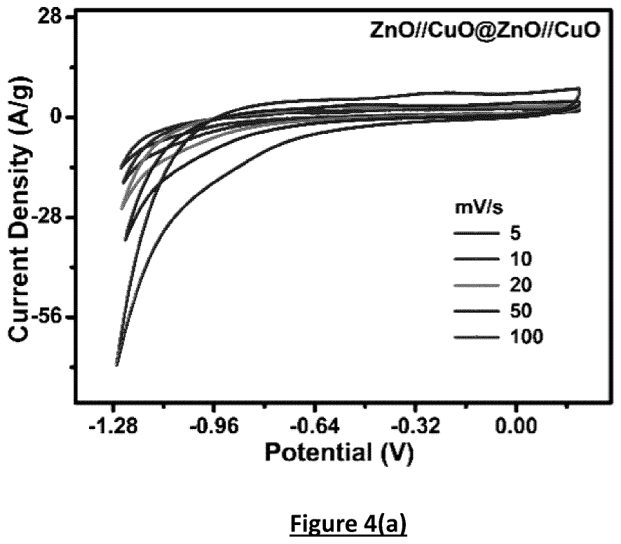

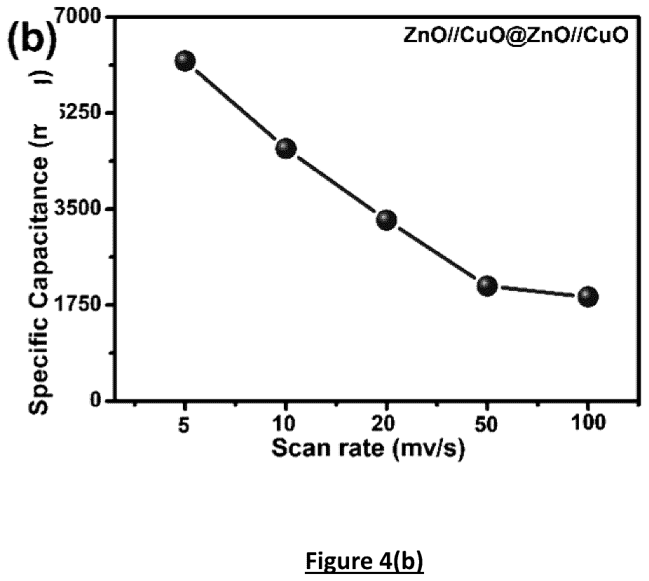

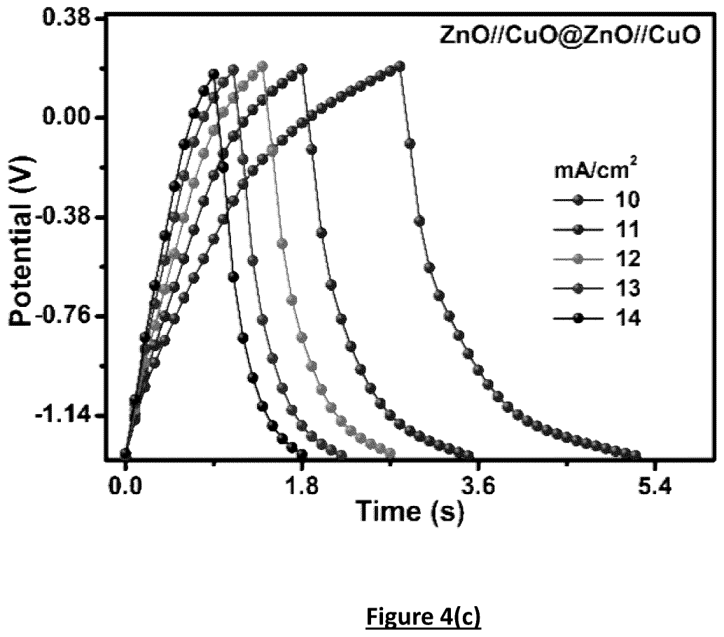

FIG. 3(a) illustrates the CV plot at different sweep rate of ZnO//CuO nanocomposite electrode in accordance with an embodiment of the present disclosure;

FIG. 3(b) illustrates Cs in F/g vs sweep rate in mV/s of ZnO//CuO nanocomposite electrode in accordance with an embodiment of the present disclosure;

FIG. 3(c) illustrates the GCD plot at dissimilar current density in mA/cm² of ZnO//CuO nanocomposite electrode in accordance with an embodiment of the present disclosure;

FIG. 3(d) illustrates regon plot of Cs vs current density of ZnO//CuO nanocomposite electrode in accordance with an embodiment of the present disclosure;

FIG. 3(e) illustrates stability plot;

FIG. 3(t) and the Nyquist plot with matching circuit of ZnO//CuO nanocomposite electrode in accordance with an embodiment of the present disclosure;

### Electrochemical Studies

Cyclic voltammetry: The CV curves exhibit distinct pseudocapacitive characteristics, as illustrated in FIG. 3 (a). The well-defined redox peaks observed are attributed to a redox mechanism of ZnO and CuO. The peak current rises nearly linearly through sweep rate, indicating that the redox processes are diffusion-controlled. Additionally, the presence of a minor peak during the charging phase suggests reversible structural changes in the electrodes as K⁺ ions are deintercalated. These observations highlight the rapid and reversible redox processes of the ZnO//CuO nanocomposite with K⁺ ions, underscoring its outstanding supercapacitive performance. The specific capacitance (Cs) of a ZnO//CuO nanocomposite electrode was assessed through CV in a 1M KOH electrolyte at various sweep rates. At sweep rate of 2 mV/s, an electrode demonstrated a notable Cs of 819.4 F/g, indicating its robust charge storage capacity. However, an increase in sweep rate led to a decline in Cs, with values of 250-255 F/g at 5 mV/s, to 94-99 F/g at 100 mV/s, as exposed in FIG. 3(b). An elevated Cs observed at lower scan rates suggests that the ZnO//CuO nanocomposite electrode features a substantial surface area and a highly porous structure, which enhances ion diffusion and charge transfer. These results highlight the ZnO//CuO nanocomposite as a auspicious candidate for higher concert supercapacitors, balancing energy storage capability with rate performance.

Galvanostatic charge-discharge: The GCD profiles of the ZnO//CuO nanocomposite electrode, as exposed in FIG. 3 (c), illustrate a voltage variation over time at dissimilar current densities ranging from 10-35 mA/cm². A discharge time decreases with increasing current density, indicating changes in the electrode's capacitance under varying load conditions. At a lower current density of 10 mA/cm², an electrode shows a longer discharge time, reflecting a higher Cs. Conversely, at a current density of 35 mA/cm², the discharge time is significantly shorter, suggesting diminished capacitive performance, likely due to increased internal resistance and reduced efficiency in charge storage. The Cs values, shown in a bar graph in FIG. 3 (d), further confirm this observation. The Cs values decline as a current density increase, starting at 70-74 F/g at 10 mA/cm² and falling to 10-14 F/g at 35 mA/cm². This reduction in Cs with higher current densities is a common characteristic of supercapacitor electrodes. At elevated current densities, the reduced time available for ion diffusion and charge transfer leads to less effective utilization of the active material, thereby decreasing the overall capacitance. Additionally, the noticeable increase in internal resistance, as evidenced by the IR drop in the GCD curves, exacerbates this effect, as ions face greater resistance during charge-discharge cycles at higher current densities. Thus, the ZnO//CuO nanocomposite electrode demonstrates a decreasing Cs with rising current density, highlighting the need to carefully optimize current density to achieve an optimal balance between power density and energy storage capacity in supercapacitor applications.

### Stability Analysis of ZnO//CuO Nanocomposite Electrode

The stability curve shown in FIG. 3 (e) highlights the cycling concert of a ZnO//CuO nanocomposite electrode over 6000 cycles at a sweep rate of 100 mV/s. The Cs initially measured at 70-75 F/g exhibits a gradual decline, stabilizing at approximately 85% of its actual value after 6000 cycles. This level of capacitance retention demonstrates the remarkable stability and durability of the ZnO//CuO nanocomposite. The observed decrease in Cs over extended cycling is likely due to factors such as potential structural changes, partial dissolution of an active material, or minor dilapidation of an electrode's electrochemical interface. Nevertheless, the high retention rate underscores the material's robust performance and suggests its suitability for long-term energy storage in supercapacitor applications.

### Electrochemical Impedance Spectroscopy

The EIS extents have performed at an OCP of −0.8965 V in a 1M KOH electrolyte, spanning a frequency ranging from 100 Hz to 1 MHz, to assess an internal resistance and capacitive properties of the ZnO//CuO nanocomposite electrode. The Nyquist plot shown in FIG. 3 (f) provides a detailed analysis of the impedance characteristics. The plot indicates a good agreement among an experimental data and a theoretical model, as represented by an equivalent circuit diagram inset in the figure. Key parameters derived from the circuit model include a solution resistance (R_{S}) of 1.576Ω, charge transfer resistance (RCT) of 823.2Ω, a leakage resistance (R_{L}) of 0.1925Ω, and constant phase elements (CPEs) with values of 2.058×10⁻⁴ F and 2.146×10⁻⁴ F. The Warburg impedance is measured at 2.376×10⁹ F. The small semicircle observed in aa higher frequency region reflects a charge transfer resistance, while a linear feature in a lower frequency range is indicative of diffusion processes. These findings confirm the robust electrochemical performance of a ZnO//CuO nanocomposite electrode.

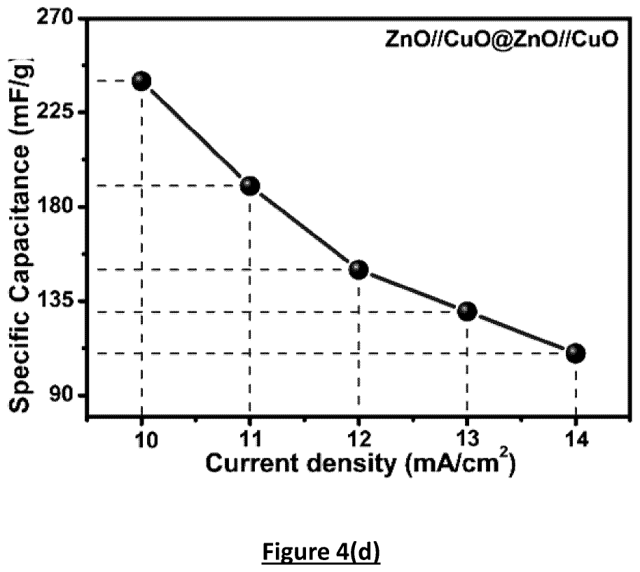

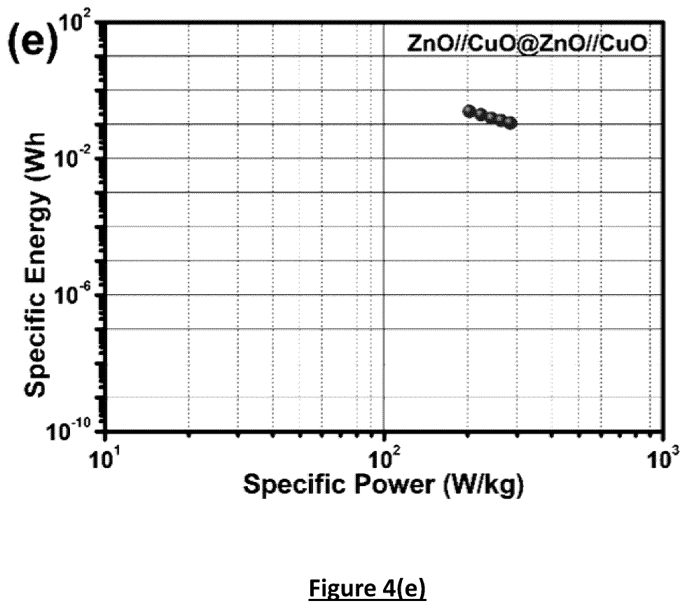

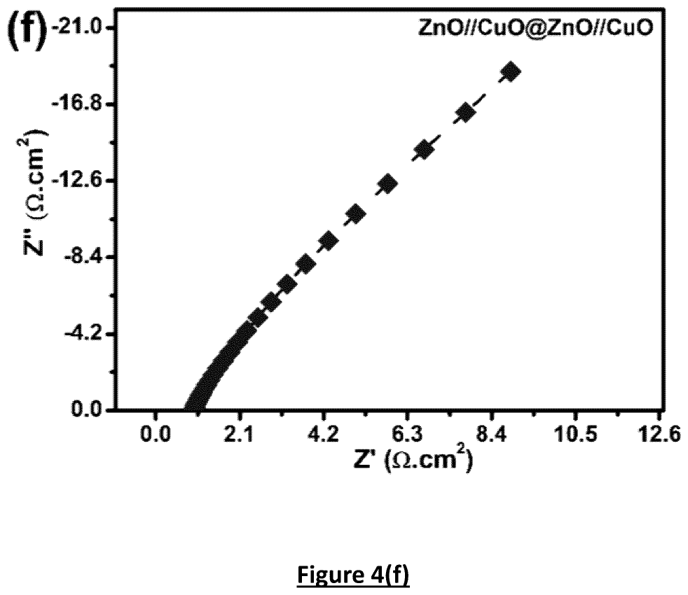

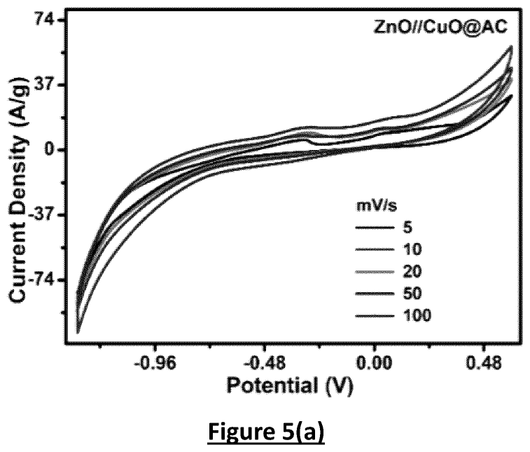

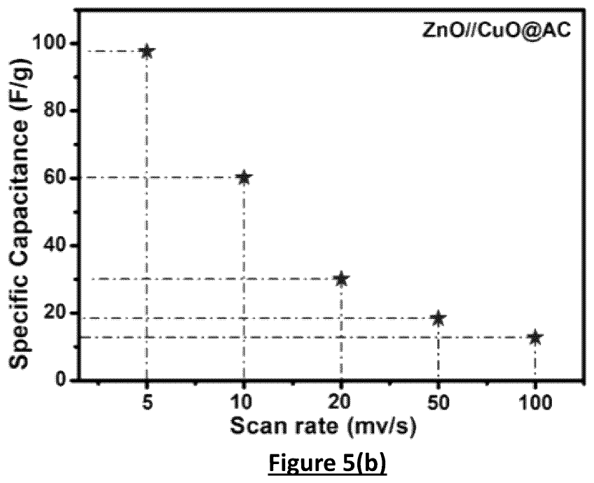

FIG. 4(a) illustrates the CV plot at different sweep rate from 5-100 mV/s of symmetric solid-state device (ZnO//CuO@ZnO//CuO) in accordance with an embodiment of the present disclosure;

FIG. 4(b) illustrates the Cs in mF/g vs sweep rate in mV/s of symmetric solid-state device (ZnO//CuO@ZnO//CuO) in accordance with an embodiment of the present disclosure;

FIG. 4(c) illustrates the GCD plot from 10-14 current density in mA/cm² of symmetric solid-state device (ZnO//CuO@ZnO//CuO) in accordance with an embodiment of the present disclosure;

FIG. 4 (d) illustrates the regon plot of Cs vs current density of symmetric solid-state device (ZnO//CuO@ZnO//CuO) in accordance with an embodiment of the present disclosure;

FIG. 4 (e) illustrates the regon graph of SE in Wh/kg vs SP in W/kg of symmetric solid-state device (ZnO//CuO@ZnO//CuO) in accordance with an embodiment of the present disclosure;

FIG. 4(f) illustrates the the Nyquist plot of symmetric solid-state device (ZnO//CuO@ZnO//CuO) in accordance with an embodiment of the present disclosure;

FIG. 4 (a-f): illustrates (a) The CV plot at different sweep rate from 5-100 mV/s, (b) Cs in mF/g vs sweep rate in mV/s, (c) the GCD plot from 10-14 current density in mA/cm², (d) regon plot of Cs vs current density, (e) regon graph of SE in Wh/kg vs SP in W/kg, and (f) the Nyquist plot of symmetric solid-state device (ZnO//CuO@ZnO//CuO) in accordance with an embodiment of the present disclosure.

### Electrochemical Analysis of Symmetric Solid-State (ZnO//CuO@ZnO//CuO) Device

### Cyclic Voltammetry

The CV curves displayed in FIG. 4(a) show a capacitive characteristic of the ZnO//CuO@ZnO//CuO device at numerous sweep rates ranging from 5-100 mV/s. As the sweep rate increases, there has a noticeable decline in an area of a CV curves, reflecting a reduction in the charge storage capability. The curves display a nearly rectangular shape, particularly at lower scan rates, indicating that double-layer capacitance is the primary mechanism, with a smaller contribution from pseudocapacitance. The specific capacitance values obtained from these curves are 6000 to 1900 mF/g for sweep rates of 5-100 mV/s, respectively, as shown in FIG. 4(b). This decline in Cs with higher scan rates can be credited to a restricted ion diffusion into an electrode material, which becomes more significant at elevated scan rates.

### Galvanostatic Charge Discharge

The FIG. 4(c) presents the galvanostatic charge-discharge (GCD) plots for varying current densities among 10-14 mA/cm². The curves display a linear and nearly symmetrical shape, indicative of favorable capacitive performance and minimal resistance. The specific capacitance values obtained from these GCD measurements are 230 to 105 F/g for current densities of 10 to 14 mA/cm², correspondingly, as demonstrated in FIG. 4(d). A decrease in Cs with growing current density has due to a reduced time available for ion diffusion and charge storage at higher densities. This analysis confirms that the solid-state device maintains stable capacitive performance across various current densities, making it suitable for practical energy storage applications. The Ragone graph in FIG. 4(e) shows a relationship among SE and SP for the device. The specific energy values are 1 to 0.5 Wh/kg, while the specific power values are 200 to 300 W/kg. The device achieves a favorable balance between energy and power densities, essential for applications that require both high energy and power. The high specific power at moderate energy levels suggests that the device can rapidly deliver energy with minimal loss, which is a desirable trait for supercapacitors.

### Electrochemical Impedance Spectroscopy

The FIG. 4(f) shows a Nyquist plot, which offers insights into the internal resistance and ion transport properties of the solid-state device. The plot shows a small semicircle at high frequencies, indicative of a low (Rct) and efficient ion exchange at an electrode-electrolyte interface. A point where the plot intersects a real axis agrees to an (ESR), measured at approximately 1Ω, reflecting minimal internal resistance. The nearly vertical line observed at low frequencies points to excellent capacitive performance and highlights the device high-frequency response. This electrochemical impedance spectroscopy (EIS) analysis emphasizes a low resistance and strong higher frequency characteristics of the device, both crucial for applications requiring high power.

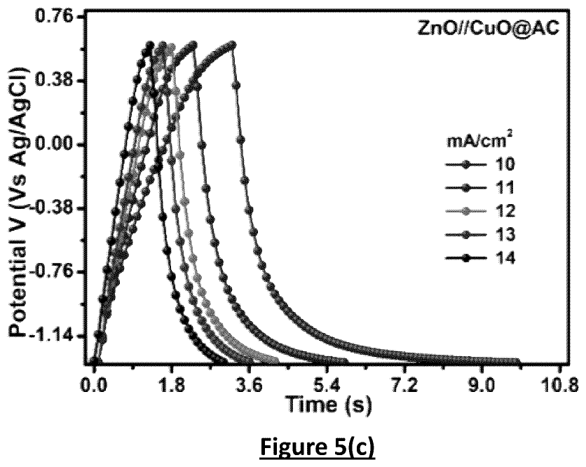

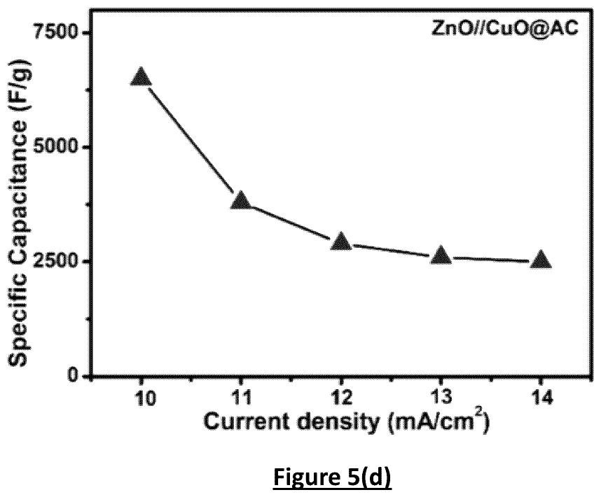

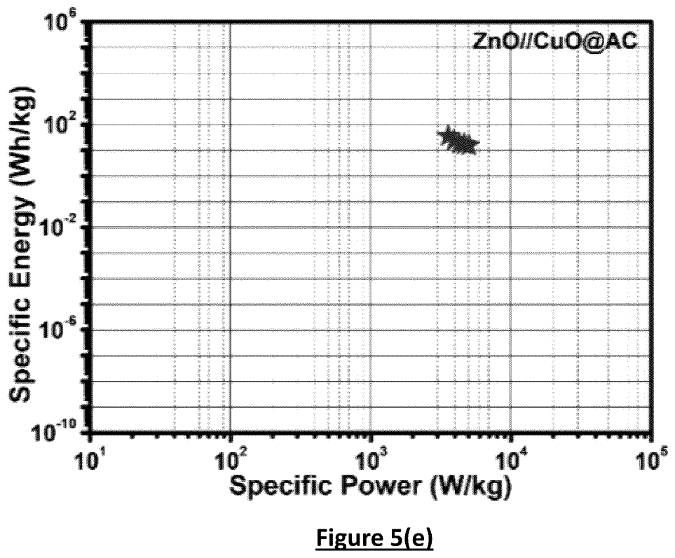

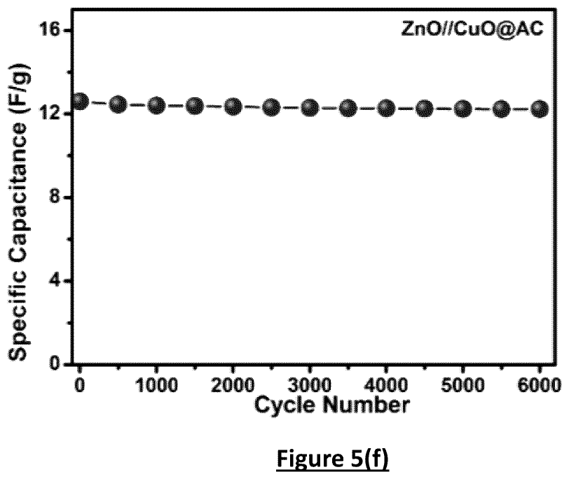

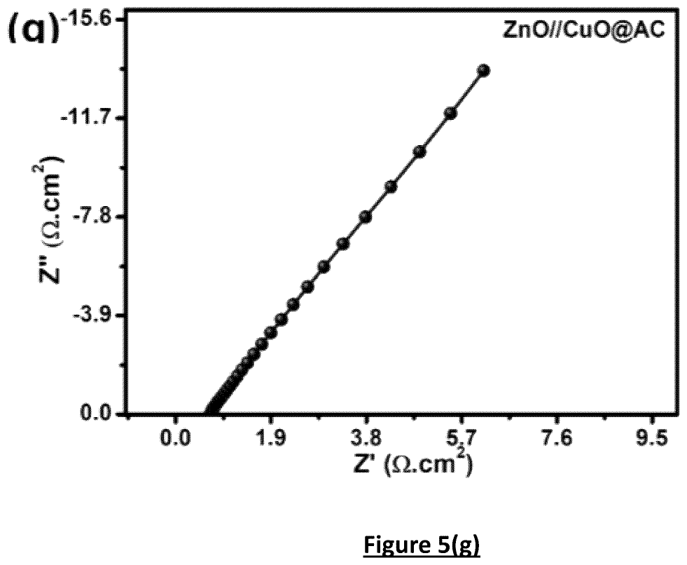

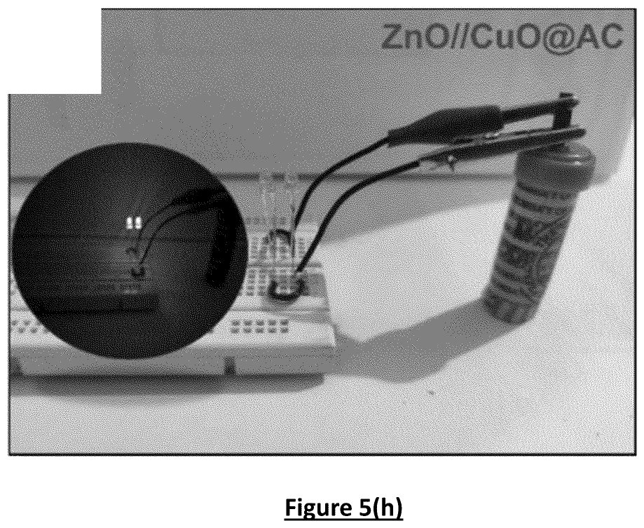

FIG. 5(a) illustrates the CV plot at different sweep rates from 5-100 mV/s of the asymmetric solid-state device (ZnO//CuO@AC) in accordance with an embodiment of the present disclosure;

FIG. 5(b) illustrates the Cs in mF/g vs sweep rate in mV/s of the asymmetric solid-state device (ZnO//CuO@AC) in accordance with an embodiment of the present disclosure;

FIG. 5(c) illustrates the GCD plot from 10-14 current density in mA/cm² of the asymmetric solid-state device (ZnO//CuO@AC) in accordance with an embodiment of the present disclosure;

FIG. 5(d) illustrates the regon plot of Cs vs current density of the asymmetric solid-state device (ZnO//CuO@AC) in accordance with an embodiment of the present disclosure;

FIG. 5(e) illustrates the regon plot of SE in Wh/kg vs SP in W/kg of the asymmetric solid-state device (ZnO//CuO@AC) in accordance with an embodiment of the present disclosure;

FIG. 5(f) illustrates the stability plot of the asymmetric solid-state device (ZnO//CuO@AC) in accordance with an embodiment of the present disclosure;

FIG. 5(g) illustrates the Nyquist plot of the asymmetric solid-state device (ZnO//CuO@AC) in accordance with an embodiment of the present disclosure;

FIG. 5(h) illustrates the actual photograph of the device with a glowing green LED light using the asymmetric solid-state device (ZnO//CuO@AC) in accordance with an embodiment of the present disclosure;

FIG. 5 (a-h): illustrates (a) The CV plot at different sweep rate from 5-100 mV/s, (b) Cs in mF/g vs sweep rate in mV/s, (c) the GCD plot from 10-14 current density in mA/cm², (d) regon plot of Cs vs current density, (e) regon plot of SE in Wh/kg vs SP in W/kg, (f) stability plot, (g) the Nyquist plot, and (h) actual photograph of device with glowing a Green LED light using the asymmetric solid-state device (ZnO//CuO@AC) in accordance with an embodiment of the present disclosure.

### Electrochemical Analysis of Asymmetric Solid-State (ZnO//CuO@AC) Device

### Cyclic Voltammetry

The CV plots for a ZnO//CuO@AC device, shown in FIG. 5 (a), were obtained across sweep rates ranging from 5-100 mV/s. A curves exhibit a consistent quasi-rectangular shape with minimal redox peaks at all scan rates, reflecting the device's robust rate capability and stability. The observed linear increase in current by growing sweep rates suggests that the device has low internal resistance, facilitating efficient charge transfer even at higher speeds. These characteristic highlights the device potential for applications that demand rapid energy delivery, such as in portable electronic gadgets. The FIG. 5 (b) presents a Cs of the device as a function of scan rate. At a sweep rate of 5 mV/s, a device exhibits a high Cs of 95-98 F/g, which decreases to 10-13 F/g as a sweep rate increases to 100 mV/s. This decline in capacitance with higher scan rates is a common behavior in supercapacitors, accredited to a reduced time for ions to diffuse into a deeper pore of the electrode material. Nonetheless, the device's ability to retain a substantial capacitance even at elevated scan rates highlights the ZnO//CuO@AC system's effectiveness in sustaining charge storage performance across a range of operational speeds.

### Galvanostatic Charge Discharge

The FIG. 5 (c) illustrates a GCD curves for numerous current densities ranging from 10-14 mA/cm². These curves are crucial for assessing the supercapacitor's charge-discharge performance and its energy storage capacity. The curves display a nearly triangular profile, indicative of effective capacitive behavior with minimal resistive losses. As the current density rises, the discharge time shortens, which is a typical response due to the faster rate of ion movement within the electrolyte. The FIG. 5 (d) displays a Cs values obtained from a GCD curves, which are 6500 to 2500 F/g for current densities of 10 to 14 mA/cm², respectively. The observed decrease in Cs through growing current density can be attributed to the limited ion accessibility to the active sites in the electrode material at higher rates. The bar graph illustrates a clear downward trend in specific capacitance as current density increases. This phenomenon is common in supercapacitors, where higher current densities result in less efficient utilization of the electrode material, as ions only interact with the surface. At lower current densities, ions have more time to penetrate a deeper pore of an electrode material, enhancing capacitance. A FIG. 5 (e) displays a Ragone plot illustrating a relationship among SE and SP for the ZnO//CuO@AC device. As depicted, specific energy, which quantifies an amount of energy stored per unit mass, decreases as specific power, indicating the rate of energy delivery, increases. This inverse relationship between energy density and power density is a typical feature of supercapacitors. A ZnO//CuO@AC device exhibits specific energy values of 32 to 16 Wh/kg for corresponding specific power values of 3500 to 5050 W/kg. These results demonstrate the device's capability to deliver energy efficiently at high rates, making it suitable for applications that demand rapid power output.

### Stability Study

The FIG. 5 (t) demonstrates a cyclic durability of a ZnO//CuO@AC device, showing a remarkable capacitance holding of 96% after 6000 charging discharging cycles. This high level of retention reflects the device's strong stability and durability over extended use. Such performance indicates that both the electrode materials and the electrolyte remain stable throughout the testing period. The slight decline in capacitance observed over numerous cycles is a common occurrence in supercapacitors, often due to gradual degradation of the electrode material or a reduction in electrolyte conductivity.

### Elecrochemical Impedance Spectroscopy

The FIG. 5 (g) presents the Nyquist plot from Electrochemical Impedance Spectroscopy (EIS) measurements. The plot indicates a low equivalent series resistance (ESR) of 0.6 ohms, signifying minimal internal resistance within the device. The plot's linear trend at lower frequencies demonstrates effective capacitive behavior, while the near-vertical line at higher frequencies highlights the device's excellent charge transfer resistance. This low ESR is essential for optimal performance, as it reduces energy losses throughout charging discharging cycles and improves an overall efficiency of a supercapacitor. The FIG. 5 (h) visually demonstrates the ZnO//CuO@AC device ability to power a green LED. The LED was lit using the energy stored in the device, illustrating its practical application as an energy storage system. This ability to power the LED directly shows the device capacity to store and deliver energy effectively, highlighting its potential for use in various electronic applications.

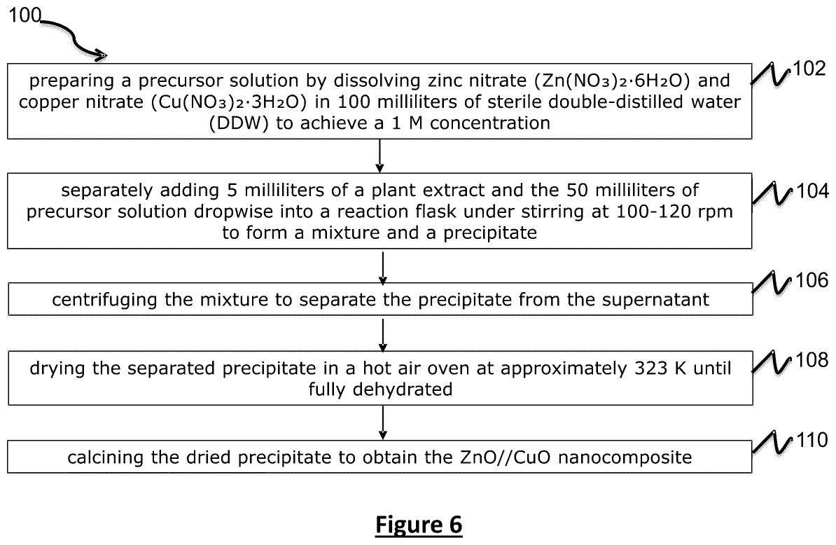

Referring to FIG. 6 a flow chart of a method for synthesizing ZnO//CuO nanocomposites for dual-mode supercapacitor devices is illustrated in accordance with an embodiment of the present disclosure.

At step (102), method (100) includes preparing a precursor solution by dissolving zinc nitrate (Zn(NO₃)₂·6H₂O) and copper nitrate (Cu(NO₃)₂·3H₂O) in 100 milliliters of sterile double-distilled water (DDW) to achieve a 1 M concentration.

At step (104), method (100) includes separately adding 5 milliliters of a plant extract and the 50 milliliters of precursor solution dropwise into a reaction flask under stirring at 100-120 rpm to form a mixture and a precipitate.

At step (106), method (100) includes centrifuging the mixture to separate the precipitate from the supernatant.

At step (108), method (100) includes drying the separated precipitate in a hot air oven at approximately 323 K until fully dehydrated.

At step (110), method (100) includes calcining the dried precipitate to obtain the ZnO//CuO nanocomposite.

At step (112) fabricating a dual-mode supercapacitor device based on based on synthesized ZnO//CuO nanocomposites, said dual-mode supercapacitor device comprising a first electrode and a second electrode, said dual-mode supercapacitor device comprising a first electrode and a second electrode, and wherein fabricating includes:
preparing a PVA-KOH gel electrolyte; immersing the first electrode, the second electrode, and a separator in the PVA-KOH gel electrolyte; assembling the supercapacitor device by pressing coated regions of the electrodes together with the separator interposed therebetween for 1 hour.

In one embodiment, the centrifugation is performed at about 8000 rpm for about 20 minutes, wherein the calcination is performed at a temperature of about 623 K for about 1 hour.

In one of the above embodiments, the plant extract is derived from Moringa oleifera leaf.

The method further comprises fabricating a symmetric supercapacitor device, comprising the steps of employing a first electrode comprising a ZnO//CuO nanocomposite and a second electrode comprising a ZnO//CuO nanocomposite, wherein the first electrode is a positive electrode and second electrode is a negative electrode. Then, deploying a separator between the first electrode and the second electrode, wherein the separator is filter paper. Then, preparing a PVA-KOH gel electrolyte and immersing the first electrode, the second electrode, and the separator in the PVA-KOH gel electrolyte for 10-15 seconds. Then, air-drying the first electrode, the second electrode, and the separator at 303 K for 1 hour. Then, coating the first electrode and the second electrode with the PVA-KOH gel electrolyte thereby drying in an electric oven at 303 K to 308 K for 6 to 8 hours to remove any adsorbed water. Thereafter, assembling the symmetric supercapacitor device by pressing the coated regions of the electrodes together with the separator interposed therebetween for 1 hour.

Yet, in one of the embodiments, the PVA-KOH electrolyte synthesis, comprising the steps of dissolving 3 grams of polyvinyl alcohol (PVA) in 40 milliliters of deionized water (DDW). Then, heating the mixture to a temperature range of 348 K to 353 K while continuously stirring to form a PVA solution. Then, cooling the PVA solution to room temperature. Then, adding 10 milliliters of a 1 M potassium hydroxide (KOH) solution to the cooled PVA solution and stirring the mixture for 6 to 7 hours to form a solution. Thereafter, pouring the resulting solution into a Petri dish and allowing to air dry at room temperature to form an alkaline gel polymer electrolyte separator.

The method further comprises fabricating an asymmetric supercapacitor device, comprising the steps of deploying a first electrode comprising activated carbon (AC) and a second electrode comprising a ZnO//CuO nanocomposite, wherein the first electrode is a positive electrode and second electrode is a negative electrode. Then, placing a separator between the first electrode and the second electrode, wherein the separator is filter paper;
immersing the first electrode, the second electrode, and the separator in a PVA-KOH gel electrolyte for 10 seconds. Then, air-drying the first electrode, the second electrode, and the separator at 303 K for 1 hour. Then, coating the first electrode and the second electrode with the PVA-KOH gel electrolyte thereby drying in an electric oven at 303 K to 308 K for 6 to 8 hours to remove any adsorbed moisture. Thereafter, assembling the asymmetric supercapacitor device by pressing the coated regions of the electrodes together with the separator interposed therebetween for 1 hour.

In another embodiment, the activated carbon (AC) electrode synthesis, comprising the steps of dissolving 1 gram of polyvinyl alcohol (PVA) in 10 milliliters of distilled water (DW). Then, heating and stirring the mixture at a temperature range of 343-353 K for 2 to 3 hours until the PVA is fully dissolved to obtain a polyvinyl alcohol (PVA) solution. Then, adding activated carbon (AC) to the PVA solution and stirring the AC-PVA mixture for an additional 2 hours at the same temperature range. Then, drying the resulting PVA-AC mixture in a desiccator to form a uniform slurry. Then, spreading the slurry onto a pre-cleaned stainless steel (SS) substrate using a doctor blade, wherein the SS substrate measures approximately 15 cm by 20 cm. then, allowing the electrode samples to dry at room temperature for 4 hours. Thereafter, heat-treating the electrode samples in a muffle furnace at 353 K for 6 to 7 hours to complete the electrode fabrication process.

Yet, in another embodiment, the Moringa oleifera leaf extract preparation, comprising the steps of cleaning fresh Moringa oleifera leaves using sterile double-distilled water (DDW) to remove any soil or impurities; shade-drying the cleaned leaves for a period of 6 to 7 days to preserve the active metabolites. Then, grinding the dried leaves into a fine powder. Then, preparing an aqueous extract by mixing 5 grams of the powdered leaves with 50 milliliters of distilled water and thoroughly mixing. Then, heating the mixture at 353 K for 30 minutes to extract active compounds; cooling the heated mixture at room temperature. Thereafter, filtering the cooled mixture to obtain a purified Moringa oleifera leaf extract thereby storing in sterile containers at 277 K.

In an embodiment, the synthesized ZnO//CuO nanocomposite undergoes a post-calcination rehydration-assisted defect engineering process involving exposure to controlled humidity of 85% RH at 308 K for 4 hours inside a sealed polypropylene chamber to intentionally induce oxygen vacancies at grain boundaries, wherein the rehydrated nanocomposite is subsequently dried under vacuum at 0.1 Torr and 353 K for 6 hours to stabilize the induced lattice disorder, and wherein Raman spectroscopic analysis is performed to confirm the emergence of defect-induced modes at approximately 570 cm⁻¹ and 610 cm⁻¹ indicative of increased charge storage site density, and wherein the centrifuged precipitate is resuspended in ethanol-water mixture with a volumetric ratio of 3:1 for 30 minutes under magnetic stirring at 600 rpm to enhance removal of unbound phytoconstituents, wherein this washing step is followed by successive sedimentation-driven decantation cycles conducted three times, and wherein the final residue is vacuum filtered using a 0.45-micron PTFE membrane and oven dried at 323 K for 18 hours under low-light conditions to prevent photodegradation of surface-adsorbed polyphenolic moieties which contribute to electron transfer efficiency.

In one detailed embodiment, the synthesized ZnO//CuO nanocomposite is subjected to a critical post-calcination rehydration-assisted defect engineering process designed to enhance its electrochemical performance, particularly in supercapacitor applications. This process begins with the placement of the calcined nanocomposite into a sealed polypropylene chamber where it is exposed to a controlled environment maintained at 85% relative humidity (RH) and a temperature of 308 K for a duration of 4 hours. The humid environment serves a dual purpose-first, it initiates a mild rehydration at the surface and grain boundaries of the nanostructures, and second, it facilitates the generation of oxygen vacancies. These vacancies, introduced under controlled moisture absorption, disrupt the local lattice ordering and increase the density of defect sites, which are well-documented contributors to enhanced charge storage capacity due to their ability to reversibly host charge carriers during redox reactions.

Following the rehydration step, the sample is immediately dried under high vacuum at 0.1 Torr and a slightly elevated temperature of 353 K for 6 hours. This step plays a vital role in stabilizing the disorder induced in the lattice without allowing structural collapse, ensuring that the newly formed oxygen vacancies are retained and immobilized within the grain boundary regions. To confirm the successful introduction of these defect sites, Raman spectroscopic analysis is performed on the dried material. The observation of new vibrational modes centered around 570 cm⁻¹ and 610 cm⁻¹, which are characteristic of oxygen vacancy-related local vibrational states in transition metal oxides, serves as strong evidence for the presence of these defect features and their spatial coherence.

Subsequent to the defect engineering process, the nanocomposite is subjected to a purification protocol aimed at removing residual phytoconstituents that might interfere with the interfacial electron transfer processes. The solid precipitate is re-dispersed in an ethanol-water mixture with a precise volumetric ratio of 3:1. The ethanol acts as an organic solvent to dissolve non-polar plant-derived residues, while water aids in dispersing hydrophilic impurities. The suspension is stirred magnetically at 600 rpm for 30 minutes to ensure uniform mixing and detachment of loosely bound organic components from the nanoparticle surfaces. After this homogenization, three successive sedimentation-driven decantation cycles are performed. Each cycle allows the heavier nanocomposite particles to settle while the supernatant containing solubilized and suspended impurities is decanted, thereby refining the sample without excessive centrifugation that could lead to particle agglomeration.

The washed residue is then subjected to fine filtration using a 0.45-micron polytetrafluoroethylene (PTFE) membrane, which effectively retains the nanoparticles while allowing smaller organic molecules and solvents to pass through. The filtered nanocomposite is then oven-dried at 323 K for 18 hours under low-light conditions. This temperature ensures gradual solvent removal while preserving the integrity of thermally sensitive surface functionalities, especially polyphenolic moieties that may be adsorbed on the nanoparticle surface due to the use of plant extracts during green synthesis. These polyphenols are known to improve the electron transfer efficiency at the electrode-electrolyte interface, acting as redox mediators or conductive bridges, and their photodegradation must be avoided to preserve the charge transfer kinetics of the final electrode. This entire sequence—from humidity-induced defect formation to surface purification and gentle drying-ensures the final ZnO//CuO nanocomposite not only possesses a high density of electrochemically active defect sites but also maintains surface chemistry that favors rapid electron exchange, making it highly suitable for use in high-performance supercapacitor devices.

In an embodiment, both the first and second electrodes comprising ZnO//CuO nanocomposites are independently fabricated via dual solvent-phase slurry casting using N,N-Dimethylformamide and ethanol in a 3:2 ratio to adjust viscosity and optimize nanoparticle dispersion, wherein the slurry mixture includes 90 wt. % ZnO//CuO composite, 5 wt. % conductive carbon black, and 5 wt. % carboxymethyl cellulose binder, wherein the slurry is homogenized by triple-stage ultrasonication-pulse stirring-ultrasonication at 40 kHz, 300 rpm, and 40 kHz respectively, and wherein the film is cast using a doctor blade set at 150 μm clearance and vacuum dried at 333 K for 24 hours before mechanical pressing at 8 MPa to achieve uniform thickness and density, and wherein the separator is engineered by pre-soaking commercial cellulose filter paper in a 0.2 wt. % aqueous solution of poly(ethylene glycol) diglycidyl ether (PEGDGE) for 1 hour followed by thermal crosslinking at 363 K for 2 hours to enhance mechanical and ionic dimensional stability, wherein the crosslinked separator is then immersed in the PVA-KOH electrolyte for 30 minutes and gently blotted using a nitrogen stream, and wherein the resulting ionomer-enhanced separator exhibits a dimensional shrinkage rate below 1% after 100 thermal cycles between 298 K and 373 K, verified by in situ optical profilometry.

In an embodiment of the disclosed invention, the first and second electrodes of the ZnO//CuO-based asymmetric supercapacitor are individually fabricated through a precise dual solvent-phase slurry casting technique that ensures optimal nanoparticle dispersion and structural uniformity. This technique utilizes a solvent mixture comprising N,N-Dimethylformamide (DMF) and ethanol in a 3:2 volumetric ratio. The specific ratio is chosen to modulate the rheological properties of the slurry where DMF contributes to high dielectric dispersion of the ZnO//CuO nanoparticles and ethanol aids in rapid solvent evaporation, thereby promoting uniform deposition and preventing agglomeration during film formation. The active slurry composition includes 90 weight percent of the ZnO//CuO nanocomposite, which serves as the primary pseudocapacitive material, 5 weight percent conductive carbon black to provide electronic percolation pathways, and 5 weight percent carboxymethyl cellulose (CMC) which functions as a water-compatible polymeric binder ensuring mechanical adhesion and flexibility.

The slurry preparation process is carried out in a three-stage homogenization cycle designed to maximize dispersion stability and particle-surface interaction. Initially, the slurry is subjected to ultrasonication at 40 kHz, which breaks up large agglomerates and initiates nanoparticle deagglomeration. This is followed by magnetic pulse stirring at 300 rpm for 20 minutes to maintain colloidal equilibrium and enhance binder dispersion throughout the matrix. Finally, a second round of ultrasonication at the same frequency ensures that the nanoparticulate system achieves a fine, uniform consistency necessary for high-performance film casting. The homogeneously dispersed slurry is then cast onto a suitable current collector substrate using a doctor blade set to a fixed clearance of 150 μm, ensuring consistent film thickness and avoiding edge-thinning artifacts common in uncontrolled manual deposition.

Following film deposition, the coated electrodes are subjected to vacuum drying at 333 K for 24 hours to remove residual solvents without causing thermal degradation of the CMC binder. This slow, low-temperature drying step preserves the porosity and microstructure required for efficient ionic access during device operation. After drying, the electrodes are mechanically compressed under 8 MPa pressure using a calibrated hydraulic press to improve film density and enhance particle contact, which in turn reduces internal resistance and improves electron mobility across the electrode plane.

In parallel, the separator material is carefully engineered to provide ionic conductivity, thermal stability, and mechanical integrity. Commercial-grade cellulose filter paper is pre-soaked in a 0.2 weight percent aqueous solution of poly(ethylene glycol) diglycidyl ether (PEGDGE), a flexible and bi-functional crosslinker that reacts with hydroxyl groups on cellulose under thermal conditions. The soaked paper is then thermally crosslinked at 363 K for 2 hours in a controlled oven to form a semi-interpenetrating polymer network. This crosslinking imparts both dimensional stability and enhanced ionic permeability, preventing mechanical degradation and pore collapse during repeated charge-discharge cycles.

Once crosslinked, the separator is immersed in a pre-prepared PVA-KOH gel electrolyte for 30 minutes to allow full absorption and ionic impregnation. After impregnation, a gentle nitrogen stream is applied to blot excess electrolyte and to ensure a uniform, bubble-free surface. The final separator, now embedded with ion-conducting moieties and stabilized via PEGDGE crosslinking, is tested for thermal and dimensional robustness. Using in situ optical profilometry, it is verified that the separator maintains a dimensional shrinkage rate below 1% after 100 thermal cycles ranging from 298 K to 373 K, confirming its suitability for long-term operational reliability under variable environmental conditions. This embodiment ensures that each component of the supercapacitor—the active electrodes and the ionic separator—is precisely engineered to maximize electrochemical efficiency, minimize resistive losses, and ensure mechanical durability under real-world cyclic loading conditions. The combination of optimized solvent-phase casting, controlled drying, and polymer crosslinking exemplifies the technical efficacy required for next-generation high-performance supercapacitor devices.

In an embodiment, the PVA-KOH gel electrolyte is synthesized using a controlled-rate heating protocol wherein the temperature is increased in 1 K/min increments from 298 K to 353 K to avoid polymer chain breakage, wherein continuous mechanical stirring at 400 rpm is maintained using a Teflon-coated impeller to avoid vortex-induced gelation inconsistencies, wherein upon complete dissolution, the solution is subjected to vacuum degassing at 0.01 Torr for 20 minutes to eliminate entrapped air bubbles, and wherein the resultant gel is cast in a level-grade silicone mold and allowed to dry in a nitrogen-flushed desiccator at 298 K for 72 hours to attain uniform gel polymerization with optimal ion mobility.

In one embodiment, the PVA-KOH gel electrolyte essential to the functioning of the ZnO//CuO-based asymmetric supercapacitor is synthesized through a rigorously controlled thermal and mechanical processing protocol designed to preserve the polymer's structural integrity and ensure homogeneity of the ion-conducting medium. The process initiates with the dissolution of polyvinyl alcohol (PVA) in deionized water followed by the addition of potassium hydroxide (KOH) to create the desired gel electrolyte matrix. To prevent thermal degradation and to avoid the risk of polymer chain scission, which could reduce both mechanical resilience and ionic conductivity, the temperature of the mixture is gradually raised from 298 K to 353 K at a finely tuned rate of 1 K/min. This slow ramping is critical for allowing the polymer chains to relax and uniformly interact with the ionic species, thereby ensuring a stable crosslinked gel without hotspots or localized chain entanglement.

Throughout this heating process, the mixture is subjected to continuous mechanical stirring at 400 rpm using a Teflon-coated impeller. This specific setup avoids the introduction of shear-induced artifacts or vortex formation, which can cause inconsistent gelation and microbubble entrapment. The use of a Teflon-coated impeller is particularly important as it ensures chemical inertness and prevents contamination or unwanted side reactions with the strong alkaline electrolyte, thus preserving the electrochemical purity of the gel.

Once the PVA and KOH are fully dissolved into a homogenous solution—typically indicated by the complete disappearance of particulate matter and attainment of a clear viscous fluid—the next step involves vacuum degassing. The solution is placed under a vacuum of 0.01 Torr for 20 minutes to eliminate any entrained air bubbles that could have been introduced during mixing or heating. These microbubbles, if left unaddressed, could result in dielectric inconsistencies, poor electrode-electrolyte interface contact, and ultimately reduced device capacitance and cycling stability. Therefore, the vacuum degassing step is a critical part of the quality control process, ensuring uniform bulk density and consistent electrical performance.

After degassing, the electrolyte is cast into a level-grade silicone mold which ensures flatness and geometric consistency, attributes that are critical for reproducible device assembly and interface conformity between the electrodes and the electrolyte layer. The mold is then transferred to a nitrogen-flushed desiccator where it is allowed to dry at a constant temperature of 298 K for a duration of 72 hours. The inert nitrogen atmosphere prevents oxidative degradation of the gel matrix and inhibits atmospheric moisture absorption during the critical drying phase. This extended drying period under low temperature ensures gradual solvent evaporation and complete polymer gelation, producing a solid-state gel with excellent mechanical flexibility and ionic mobility.

The final PVA-KOH gel produced through this protocol exhibits uniform polymer chain crosslinking, minimized ionic diffusion path tortuosity, and consistent phase behavior across the volume of the electrolyte. These attributes collectively enhance ion transport, reduce internal resistance, and contribute significantly to the long-term electrochemical stability and energy storage efficiency of the assembled supercapacitor device.

In an embodiment, the activated carbon electrode comprises a thermally pre-treated activated carbon precursor subjected to staged annealing at 473 K for 3 hours and 673 K for 2 hours under argon gas to modulate surface oxygen functional groups, wherein the pre-treated carbon is milled to <50 nm using a planetary ball mill at 500 rpm with zirconia media for 6 hours, and wherein the resultant powder is dispersed in a 0.5% PVA aqueous matrix and blade-cast onto acid-etched stainless steel foil pretreated with UV-ozone cleaning for 15 minutes to enhance surface energy and binding integrity before air-drying for 4 hours and sintering in a vacuum oven at 373 K, and wherein the asymmetric electrode pair comprising activated carbon and ZnO//CuO composite is thermally balanced via annealing both electrodes at 343 K for 2 hours in a single chamber with temperature uniformity of ±0.2 K, wherein the composite electrode is pre-charged to 0.8 V for 30 minutes in a three-electrode configuration using a potentiostat before final assembly to activate redox states, and wherein the assembled supercapacitor is allowed to equilibrate for 12 hours under static load-free conditions before any electrochemical characterization is conducted.

In this embodiment, the activated carbon (AC) electrode for the asymmetric ZnO//CuO supercapacitor device is fabricated through a series of thermally and chemically optimized processes that ensure the retention of high surface area, enhanced surface chemistry, and excellent electronic conductivity. The process begins with the thermal pre-treatment of the activated carbon precursor, which is subjected to a staged annealing protocol in an inert argon atmosphere. The first annealing stage at 473 K for 3 hours serves to desorb physisorbed moisture and volatile organic impurities, while also partially modulating the oxygen-containing functional groups such as hydroxyl, carboxyl, and carbonyl groups. These surface functionalities are crucial for facilitating pseudocapacitive interactions and enhancing wettability. The second annealing stage, conducted at 673 K for 2 hours, further restructures the surface to introduce defect sites while minimizing excessive graphitization, thereby retaining a high degree of microporosity and facilitating rapid ion diffusion.

Following thermal treatment, the activated carbon is subjected to particle size reduction using a planetary ball mill operated at 500 rpm for 6 hours. Zirconia media is specifically chosen to prevent contamination and introduce minimal frictional heat, while the process yields nanopowder with particle sizes below 50 nm. This fine particulate form is critical for ensuring high electrode packing density and improved interfacial contact with the binder system.

The resulting nanopowder is then dispersed in a 0.5% aqueous solution of polyvinyl alcohol (PVA), forming a stable slurry. This PVA solution acts as both a binder and a mild surfactant, helping to maintain particle dispersion while providing mechanical cohesion in the final film. The AC-PVA slurry is blade-cast onto acid-etched stainless steel foil substrates that have undergone UV-ozone cleaning for 15 minutes. This surface preparation step increases the surface energy of the substrate, thereby enhancing the adhesion between the stainless steel and the carbonaceous film, and ensuring strong mechanical bonding during subsequent electrochemical cycling.

After coating, the electrode is air-dried at ambient conditions for 4 hours to remove water without causing abrupt binder solidification, which could lead to film cracking or pore blockage. The dried electrode is then sintered in a vacuum oven at 373 K to remove residual water, densify the film, and improve the physical and chemical interaction between the carbon particles and the binder without causing thermal degradation of the polymeric matrix.

To ensure thermal balance and symmetric thermal stress across the asymmetric cell components, both the AC electrode and the ZnO//CuO composite electrode are co-annealed at 343 K for 2 hours inside a single heating chamber, which is maintained with a high degree of thermal uniformity (±0.2 K). This step ensures that residual stresses, film curvatures, and surface energies are harmonized across both electrodes prior to device assembly, preventing delamination or structural mismatch during operation.

Prior to final device assembly, the ZnO//CuO electrode is electrochemically pre-charged to 0.8 V for 30 minutes in a three-electrode configuration using a precision potentiostat. This pre-conditioning step partially activates redox states in the Zn and Cu sites, establishing initial pseudocapacitive pathways and improving immediate device performance upon cycling. Finally, after assembling the AC and ZnO//CuO electrodes into a full-cell configuration, the supercapacitor is allowed to equilibrate under static, load-free conditions for 12 hours. This resting period allows for ionic redistribution, interfacial wetting, and relaxation of the polymeric and carbon-based components, which are crucial for consistent and stable electrochemical performance during subsequent characterization.

This carefully choreographed embodiment ensures that both the AC and ZnO//CuO electrodes are structurally, thermally, and electrochemically optimized to function synergistically in an asymmetric configuration, delivering high energy density, low internal resistance, and robust long-term cycling stability.

In an embodiment, the prepared AC-PVA slurry is subjected to colloidal stability analysis using dynamic light scattering to confirm zeta potential greater than ±30 mV indicating electrostatic repulsion between particles, wherein the slurry is then subjected to pH adjustment using dilute ammonia to reach a value of 10.5 prior to casting, and wherein the electrode coating process employs a three-pass tape casting method using a custom-built linear applicator with stepwise layering, ensuring total film thickness within ±5 μm across a 15 cm×20 cm substrate, with thermal ramping from 303 K to 353 K under argon flow to remove solvents without bubble nucleation, and wherein the muffle furnace used for thermal curing of the AC electrode includes a feedback-controlled PID loop with embedded IR thermocouples positioned directly beneath the sample stage to maintain real-time temperature deviation below ±0.1 K, wherein the sample is mounted on alumina crucibles to ensure thermal insulation from metallic heat sinks, and wherein the ramp rate during final 90 minutes of curing is reduced to 0.5 K/min to promote stable binder reflow without phase collapse of the AC matrix.

In this embodiment, the fabrication of the activated carbon (AC) electrode from the AC-PVA slurry is refined through a sequence of carefully monitored physicochemical steps aimed at maximizing coating uniformity, colloidal stability, and binder integration, all of which directly contribute to the electrochemical performance and mechanical robustness of the final device. The process begins with the preparation of a homogeneous AC-PVA slurry, which is subjected to dynamic light scattering (DLS) analysis to measure the zeta potential—a critical parameter indicating the degree of electrostatic repulsion among suspended particles. A zeta potential magnitude greater than ±30 mV confirms sufficient electrostatic stabilization, effectively preventing particle aggregation and sedimentation during the casting process, which is crucial for achieving uniform surface morphology and consistent electrode characteristics.

Once colloidal stability is verified, the slurry undergoes a precise pH adjustment to a value of 10.5 using dilute aqueous ammonia. This pH tuning step is essential for enhancing the deprotonation of functional groups on the AC surface and ensuring better interaction with the PVA matrix, ultimately leading to improved film formation and binder distribution. The alkaline environment also facilitates better dispersibility of the carbon particles, further contributing to slurry homogeneity prior to casting.

For electrode film deposition, a sophisticated three-pass tape casting method is employed using a custom-designed linear applicator. This multilayer casting approach enables stepwise layering of the slurry across a 15 cm×20 cm stainless steel or glass substrate, with each pass contributing incrementally to the total film thickness. This technique ensures that the cumulative thickness variation across the substrate does not exceed ±5 μm, thereby enhancing reproducibility and uniformity in electrochemical response. Each layer is semi-dried before the next pass is applied to prevent interlayer mixing and to maintain structural integrity.

Following deposition, the electrode undergoes thermal ramping from 303 K to 353 K under an argon flow environment. The inert atmosphere prevents oxidation of both the carbon matrix and PVA binder during solvent evaporation. This ramping is carefully controlled to avoid rapid temperature changes, which could cause solvent bubble nucleation, binder cracking, or phase discontinuities in the electrode film. A controlled atmosphere and gradual heating ensure defect-free drying and uniform film densification.

The final curing of the electrode is conducted in a muffle furnace equipped with a feedback-controlled Proportional-Integral-Derivative (PID) loop system. This system is integrated with embedded infrared (IR) thermocouples directly beneath the sample stage, allowing for real-time monitoring and precise thermal control. The system maintains a temperature deviation of less than ±0.1 K, which is critical for sensitive polymer systems like PVA, where temperature fluctuations can lead to uneven reflow, film warping, or partial phase segregation. The electrodes are placed on alumina crucibles during curing to provide thermal insulation and eliminate heat gradient artifacts associated with metallic heat sinks, thereby preserving microstructural uniformity.

During the final 90 minutes of the curing protocol, the temperature ramp rate is reduced to 0.5 K/min, allowing for slow and controlled binder reflow. This step promotes gradual molecular rearrangement of the PVA chains within the porous AC matrix without initiating binder phase collapse or delamination. The slow ramping stabilizes interfacial adhesion, maintains porosity required for ion diffusion, and prevents structural brittleness, ensuring the final electrode maintains mechanical resilience and electrical connectivity.

This embodiment showcases a highly engineered fabrication route that combines colloidal science, thermal physics, and precision deposition to yield activated carbon electrodes with superior structural uniformity, thermal stability, and electrochemical reliability. These electrodes form a critical component of the asymmetric supercapacitor system, directly influencing its capacitance, charge-discharge stability, and long-term operational durability.

In an embodiment, the calcination of the dried ZnO//CuO precipitate is performed in a programmable box furnace with staged ramping—initial ramping at 2 K/min to 423 K with a hold of 1 hour, followed by 5 K/min to 623 K and a secondary hold for 1 hour—to enable progressive decomposition of phytochemical residues and formation of crystalline phases, wherein this is followed by controlled furnace cooling at 1 K/min to room temperature under static nitrogen atmosphere, and wherein thermogravimetric analysis of the intermediate steps is recorded to precisely match decomposition stages to reaction profiles for reproducibility across batches, and wherein the fabricated supercapacitor device is vacuum laminated using a thin thermoplastic polyurethane (TPU) encapsulation film under 200 Pa vacuum pressure and 393 K lamination temperature, wherein the film forms a barrier layer around the device to protect from moisture ingress and air oxidation, and wherein the laminated device is post-cured under a mechanical compression rig at 100 N load for 3 hours in a humidity-controlled environment at 25% RH to ensure electrode-electrolyte integration without layer delamination.

In this embodiment, the calcination of the dried ZnO//CuO precipitate is meticulously executed to achieve controlled phase transformation, eliminate organic residues, and ensure crystallinity conducive to high electrochemical activity. The process is carried out in a programmable box furnace that facilitates multi-stage ramping under strictly regulated thermal conditions. Initially, the dried precursor is ramped at a rate of 2 K/min to a temperature of 423 K, where it is held for 1 hour. This low-temperature hold phase is crucial for the gradual evaporation and decomposition of low-molecular-weight phytochemicals and volatile constituents derived from the green synthesis route—often utilizing plant extracts rich in polyphenols and flavonoids. The slow ramping and extended dwell time prevent thermal shock, which could otherwise result in uneven grain formation or unwanted agglomeration.

Following this, the temperature is increased at a faster rate of 5 K/min to reach 623 K, where it is held for an additional hour. This higher-temperature phase initiates the nucleation and growth of crystalline ZnO and CuO phases while completing the decomposition of remaining organic matter. The careful thermal ramping ensures the development of nanocrystalline domains with minimal internal stress, optimal surface area, and defect-rich boundaries favorable for charge storage. After calcination, the system undergoes a controlled cooling phase at 1 K/min down to room temperature under a static nitrogen atmosphere. The nitrogen ambient serves to prevent oxidation beyond the desired oxidation states of zinc and copper, while the slow cooling helps preserve intergranular porosity and minimizes thermal stress that could lead to cracking or loss of mechanical cohesion.

During this entire calcination sequence, thermogravimetric analysis (TGA) is performed on representative samples from each batch to correlate mass loss events with specific thermal transitions. This analytical step allows for the creation of a reproducible thermal decomposition profile, thereby ensuring consistency across multiple synthesis batches and providing a basis for quality control in scaling up the process for industrial manufacturing.

Once the supercapacitor device has been fully assembled with electrodes and electrolyte, it undergoes an encapsulation phase to enhance environmental stability and mechanical integrity. This is achieved through vacuum lamination using a thin thermoplastic polyurethane (TPU) film. The lamination is carried out under a vacuum pressure of 200 Pa and at a lamination temperature of 393 K. TPU is chosen for its excellent flexibility, optical transparency, and resistance to water vapor and oxygen diffusion. Under these conditions, the film uniformly adheres to the contours of the device, forming a seamless encapsulating barrier that effectively shields the active components from ambient moisture and oxidative degradation.

To further improve the interface between encapsulated layers and eliminate trapped air or microbubbles that may form during lamination, the device is subjected to a post-curing step under mechanical compression. A calibrated compression rig applies a load of 100 N uniformly across the device surface for 3 hours, conducted in a humidity-controlled environment maintained at 25% relative humidity. This environment prevents moisture ingress during the critical stabilization period while the compression ensures tight physical bonding between the electrode and electrolyte layers. This step is pivotal for enhancing ion transport continuity, preventing layer delamination under mechanical or thermal cycling, and improving overall device longevity.

Collectively, this embodiment demonstrates a holistic approach to thermal processing, structural stabilization, and environmental protection, enabling the ZnO//CuO-based supercapacitor to maintain high performance and reliability across diverse operating conditions. It integrates advanced thermal management and encapsulation engineering to yield a commercially viable energy storage solution with excellent mechanical, electrochemical, and environmental resilience.

In an embodiment, electrode mass balancing is achieved by iterative coulometric titration using a constant-current charge-discharge profile at 0.5 A/g for 100 cycles on individual electrodes, wherein the mass ratio between positive and negative electrodes is calculated using extracted capacitance values and optimized to a range of 0.95-1.05 for symmetric pairing, and wherein final mass adjustment is done via micro-trimming with a precision blade under a stereomicroscope to maintain symmetrical capacitance response, and wherein the ZnO//CuO electrodes are coated on a graphene oxide-interfaced stainless steel substrate pre-functionalized with carboxyl groups via electrochemical anodization in 0.1 M oxalic acid at 15 V for 90 seconds, wherein the graphene oxide is spray-deposited at 60° C. using an ultrasonic nozzle with a flow rate of 0.25 mL/min and dried under vacuum, and wherein this surface-engineered electrode substrate is used to enhance adhesion, conductivity, and prevent interfacial delamination under long-term cycling conditions exceeding 10,000 charge-discharge cycles.

In this embodiment, precise electrode mass balancing is implemented to ensure optimal charge symmetry and long-term stability in the ZnO//CuO-based asymmetric supercapacitor device. The process begins with iterative coulometric titration conducted on the individual positive and negative electrodes using a constant-current galvanostatic charge-discharge protocol at a current density of 0.5 A/g for 100 cycles. During this stage, the specific capacitance of each electrode is extracted by analyzing the discharge curves. The total charge (Q) stored is used to derive capacitance (C=Q/ΔV), which then informs the necessary mass ratio between the two electrodes. For ideal symmetrical capacitive behavior, the mass ratio of positive to negative electrodes is adjusted to fall within a narrow range of 0.95-1.05. This range ensures that both electrodes reach full charge/discharge simultaneously, minimizing internal voltage drop, maximizing energy density, and avoiding electrode degradation due to overpotential.

Following the determination of the optimal mass ratio, fine-tuning is carried out through a micro-trimming procedure. This is performed manually using a precision blade under a high-magnification stereomicroscope, enabling controlled removal of excess material from the heavier electrode. This meticulous step ensures that the effective active surface areas are balanced, facilitating symmetrical capacitance response during real-time operation and reducing charge imbalance-induced degradation during extended cycling.

In addition to mass symmetry, this embodiment incorporates advanced surface engineering of the current collector to improve electrical conductivity, adhesion strength, and long-term interface stability. The ZnO//CuO nanocomposite slurry is cast onto stainless steel substrates that are pre-functionalized with carboxyl groups to increase surface polarity and anchoring capability. This is achieved through electrochemical anodization in a 0.1 M oxalic acid solution at a voltage of 15 V for 90 seconds. The anodization treatment introduces a dense layer of —COOH functional groups on the surface of the stainless steel, which subsequently enhances the bonding interaction with the coating materials, particularly under stress from thermal cycling or mechanical deformation.

To further elevate interfacial conductivity and prevent delamination, a layer of graphene oxide (GO) is spray-deposited onto the functionalized stainless steel surface. The deposition is carried out using an ultrasonic nozzle at a temperature of 60° C., with a controlled flow rate of 0.25 mL/min to ensure uniform coverage without oversaturation or droplet coalescence. The ultrasonic spraying technique creates a fine, even dispersion of GO sheets across the substrate. The GO-coated substrates are then vacuum-dried to remove residual solvents, solidify the GO layer, and promote adhesion between the GO and the metal oxide matrix during subsequent electrode deposition.

This composite interfacial strategy—combining carboxylated steel, GO interfacing, and precision mass control—significantly enhances the electrochemical contact at the electrode-current collector interface. It not only facilitates faster electron transport and reduced contact resistance but also mitigates mechanical peeling or microcrack formation during prolonged charge-discharge cycling. The robustness of this configuration is validated through extended cycling performance exceeding 10,000 full cycles, with minimal degradation observed in capacitance retention and equivalent series resistance (ESR), thereby confirming the long-term operational reliability of the system.

In an embodiment, real-time process monitoring is implemented using machine vision-based colorimetric feedback during gel electrolyte drying, wherein an RGB camera tracks the grayscale shift from 0.18 to 0.25 to detect gel phase transitions, wherein this image data is relayed to an embedded microcontroller that modulates a heated air blower to ensure spatially uniform evaporation, and wherein the entire process is conducted under a closed-loop feedback system for reproducibility across device batches, and wherein the final supercapacitor assembly undergoes a mechanical fatigue test simulating 5000 bending cycles at 30° curvature using a servo-driven mechanical flexor, wherein electrochemical impedance spectroscopy (EIS) is conducted before and after fatigue testing across 0.01 Hz to 100 kHz frequency range to quantify phase shift, equivalent series resistance (ESR), and charge transfer resistance variations, and wherein the device is deemed stable only if ESR variation remains within ±3% and capacitance retention exceeds 95% relative to pre-flexed state.

In this embodiment, a highly integrated real-time process monitoring system is employed during the critical gel electrolyte drying phase to ensure batch-to-batch reproducibility and optimize the spatial uniformity of the polymer matrix in the final supercapacitor device. This is achieved through the use of a machine vision-based colorimetric feedback system, where an RGB camera is strategically positioned above the drying station to continuously monitor the gel surface. The camera captures and analyzes the grayscale intensity of the gel film in real time, focusing on a shift from a grayscale value of 0.18 to 0.25, which correlates with the physical transition of the electrolyte from a semi-liquid to a solidified gel state. This shift is indicative of solvent evaporation and gel crosslinking progress, and its precise tracking ensures that drying is neither prematurely terminated nor excessively prolonged—both of which could lead to non-uniform ionic domains or surface cracking.

The grayscale data is relayed to an embedded microcontroller programmed with a closed-loop feedback algorithm. This microcontroller actively modulates the output of a heated air blower that provides convective drying to the gel surface. By dynamically adjusting airflow intensity and distribution in response to the visual feedback, the system maintains uniform evaporation rates across the gel film's surface, thus avoiding hotspots or drying gradients that could introduce compositional or mechanical inhomogeneity. The closed-loop nature of this control ensures reproducibility across device fabrication batches, enabling consistent performance characteristics in large-scale manufacturing.

Once the gel drying and electrode assembly processes are complete, the full supercapacitor device is subjected to a rigorous mechanical fatigue test designed to evaluate its structural integrity and electrochemical resilience under dynamic mechanical stress. A servo-driven mechanical flexor simulates 5000 bending cycles, each to a curvature of 30°, replicating real-world conditions such as wearables or flexible electronics. This mechanical actuation assesses the robustness of the electrode-electrolyte-substrate interfaces, encapsulation integrity, and the endurance of the internal ionic conduction network.

Before and after fatigue testing, electrochemical impedance spectroscopy (EIS) is conducted across a wide frequency range from 0.01 Hz to 100 kHz. The EIS measurements provide comprehensive insight into changes in key electrical parameters including phase angle shift, equivalent series resistance (ESR), and charge transfer resistance (RCT). These metrics are crucial indicators of the integrity of ionic pathways and electrode interfaces. A device is considered mechanically and electrochemically stable only if the ESR variation remains within ±3% and the capacitance retention exceeds 95% when compared to its pre-flexed baseline performance. This stringent threshold guarantees that the supercapacitor can withstand prolonged operational stress without significant degradation in its energy storage capacity or efficiency.

This embodiment illustrates a convergence of process automation, smart control systems, and durability testing to produce supercapacitor devices that are not only high-performing but also mechanically resilient and reliably manufacturable. The use of real-time visual feedback combined with mechanical-electrochemical validation exemplifies a comprehensive quality assurance strategy tailored for next-generation flexible energy storage platforms.

In an embodiment, after fabrication, the dual-mode supercapacitor is subjected to a two-step electrochemical activation protocol involving (i) potentiostatic hold at 1.5 V for 60 minutes in an environmental chamber maintained at 60% RH and 298 K to promote redox-active site preconditioning, and (ii) 500 galvanostatic charge-discharge cycles at 1 A/g current density to stabilize internal resistance, wherein real-time voltage drop across the device is monitored during each discharge cycle using a high-speed data acquisition system sampling at 1 kHz, and wherein activation is only considered complete once voltage sag rate between cycle 490 and 500 is below 0.01 mV/cycle.

In this embodiment, the fabricated dual-mode ZnO//CuO-based asymmetric supercapacitor undergoes a finely tuned two-step electrochemical activation protocol designed to condition redox-active materials, stabilize internal resistance, and ensure consistent device performance prior to practical deployment. This post-fabrication activation step is essential to unlock the full electrochemical potential of the electrodes by initializing redox sites, equilibrating the internal charge distribution, and minimizing early-cycle instabilities that typically arise in newly assembled systems.

The first phase of the activation process involves a potentiostatic hold at 1.5 V for 60 minutes. This is conducted inside a controlled environmental chamber maintained at 60% relative humidity and a stable temperature of 298 K. The humidity and temperature conditions are critical-they mimic ambient conditions under which the supercapacitor may operate and help maintain consistent electrolyte behavior. The potentiostatic hold serves to precondition the redox-active sites, particularly in the ZnO//CuO nanocomposite, where the application of a constant voltage helps in activating surface-bound redox pairs such as Zn²⁺/Zn⁰ and Cu²⁺/Cu⁺/Cu⁰. This process promotes the alignment of ionic and electronic pathways and enhances the interfacial wetting of the electrode-electrolyte boundary, which in turn improves ion diffusion kinetics and charge transfer dynamics during subsequent cycling.

Following redox preconditioning, the second phase of activation comprises 500 galvanostatic charge-discharge cycles conducted at a current density of 1 A/g. This repetitive cycling serves to stabilize the internal resistance (including ESR and RCT), densify the electrochemical pathways within the electrode bulk and at interfaces, and mechanically condition the internal layers through minor thermal and stress expansions. This phase not only contributes to the electrochemical stabilization of the device but also eliminates parasitic capacitance, restructures the polymeric electrolyte interface, and ensures the electrodes reach their full operational potential with minimal polarization loss.

Throughout the galvanostatic cycling process, a high-speed data acquisition system is used to monitor the voltage drop across the device during every discharge cycle. This system, sampling at 1 kHz, allows for real-time detection of microvolt-scale changes and captures the voltage sag behavior with high temporal resolution. The voltage sag—the drop in terminal voltage during constant current discharge—is a key indicator of internal resistance buildup and charge delivery efficiency. To ensure activation completeness and high-fidelity device readiness, a stringent convergence criterion is applied: activation is deemed successful only when the voltage sag rate between the 490th and 500th discharge cycles is less than 0.01 mV/cycle. This ultra-low variation threshold confirms that the device has reached a steady-state operational mode with minimal drift, indicating robust electrochemical and mechanical integration. It also ensures that the electrode interfaces are fully wetted, ion channels are saturated, and capacitance values are stabilized.

This embodiment integrates controlled environmental conditioning, electrochemical stabilization, and real-time diagnostics into a unified activation strategy, ensuring that each fabricated supercapacitor achieves peak performance, extended cycle life, and exceptional reproducibility. Such an approach is critical for high-precision energy storage applications where performance reliability under dynamic conditions is paramount.

In an embodiment, the ZnO//CuO nanocomposite used as the negative electrode in the asymmetric device is functionalized with nitrogen groups by exposing the post-calcined material to anhydrous ammonia gas at 473 K for 2 hours inside a tubular furnace, wherein the modified nanocomposite is immediately quenched to room temperature inside a nitrogen glove box to prevent re-oxidation, and wherein the nitrogen content is confirmed via XPS showing N1s peaks between 398-401 eV, corresponding to pyridinic and pyrrolic nitrogen, with a total nitrogen concentration not less than 3 at %, and wherein prior to final assembly, both the activated carbon and ZnO//CuO electrodes are exposed to UV-ozone for 5 minutes in a quartz chamber to remove surface contaminants and activate hydroxyl groups, wherein the surface energy is measured by contact angle goniometry and required to be less than 450 before proceeding, and wherein post-treatment electrodes are handled exclusively with non-particulate PTFE tweezers inside a nitrogen-filled glove box to maintain interfacial cleanliness and reproducibility.

In this embodiment, the performance of the asymmetric supercapacitor is further enhanced by nitrogen-functionalizing the ZnO//CuO nanocomposite, which is employed as the negative electrode. The nitrogen doping process is implemented after the initial calcination phase, targeting the introduction of electron-donating nitrogen species into the nanocomposite lattice or on its surface, thereby improving electrical conductivity, redox site density, and overall pseudocapacitive behavior. The post-calcined ZnO//CuO material is exposed to anhydrous ammonia (NH₃) gas inside a high-purity tubular furnace at 473 K for a duration of 2 hours. This temperature is optimally selected to promote the incorporation of nitrogen atoms into defect-rich regions and surface vacancies without triggering unwanted sintering or phase transformation.

The nitrogen atmosphere inside the furnace allows the nanocomposite to undergo surface passivation via the formation of pyridinic and pyrrolic nitrogen species-two nitrogen configurations known for their high electrochemical activity in energy storage materials. Upon completion of the exposure, the doped nanocomposite is immediately quenched to room temperature within a nitrogen-filled glove box. This rapid cooling in an oxygen-free environment is a crucial step that prevents re-oxidation or formation of unwanted surface oxides that could block active nitrogen sites or impair electron mobility. The glove box is continuously purged to maintain low oxygen and moisture levels, ensuring preservation of the newly introduced nitrogen functionalities.

To verify the success and extent of nitrogen doping, X-ray photoelectron spectroscopy (XPS) is performed, with a focus on the N1s spectral region. The appearance of distinct peaks between 398 and 401 eV confirms the presence of pyridinic (typically around 398.5 eV) and pyrrolic (around 400.1 eV) nitrogen species. For the nanocomposite to be deemed functionally doped, the total nitrogen concentration must be no less than 3 atomic percent, which ensures sufficient enhancement of surface redox activity and electronic conductivity for high-rate charge/discharge applications.

Before assembling the electrodes into a final device, both the nitrogen-functionalized ZnO//CuO electrode and the complementary activated carbon (AC) electrode are subjected to surface treatment via UV-ozone exposure in a quartz chamber. The electrodes are irradiated for 5 minutes to remove adsorbed organic contaminants, residual solvents, and airborne particulates. This process also activates hydroxyl groups on the surfaces, increasing their polarity and improving electrolyte wettability. Improved wettability is essential for minimizing interfacial resistance and ensuring efficient ionic contact across the electrode-electrolyte interface.

To quantitatively assess surface readiness for assembly, contact angle goniometry is performed. The measurement involves placing a micro-droplet of deionized water on the treated electrode surface and capturing its wetting behavior. A contact angle below 45° is set as the acceptance criterion, indicating a sufficiently high surface energy conducive to strong electrolyte adherence and uniform ionic diffusion. Surfaces failing to meet this threshold would otherwise lead to incomplete electrolyte spreading, uneven current distribution, and long-term performance degradation.

Finally, the post-treated electrodes are handled with extreme care using non-particulate polytetrafluoroethylene (PTFE) tweezers within the same nitrogen-filled glove box. This contamination-free handling protocol ensures that no particulates, oils, or moisture are reintroduced onto the cleaned and activated surfaces prior to assembly. This step preserves the integrity of the interfacial contact area and guarantees reproducibility in the electrochemical performance of the final device.

Altogether, this embodiment underscores the strategic integration of surface functionalization, cleanliness, and post-treatment control to fine-tune the electrochemical properties and interfacial reliability of the asymmetric supercapacitor, ultimately resulting in improved charge storage capacity, reduced resistance, and enhanced long-term cycle stability.

In an embodiment, the PVA-KOH electrolyte is doped with 1 wt. % lithium nitrate (LiNO₃) added to the solution after cooling to room temperature but prior to final casting, wherein the addition of LiNO₃ is intended to form ion-bridged polymer chains to reduce ionic resistance, wherein ionic conductivity is measured using a dielectric analyzer with blocking electrodes, and wherein only electrolyte batches with ionic conductivity >10⁻³ S/cm and mechanical elongation at break >150% as tested by tensile analysis are used in final device assembly, and wherein the ZnO//CuO nanocomposite is mixed with a small amount of MnO₂ nanoparticles not exceeding 3 wt. %, and wherein said MnO₂ is synthesized in situ by adding 0.05 M potassium permanganate to the precursor solution before the plant extract is introduced, wherein this doping step is conducted only after 10 minutes of precursor aging to prevent premature oxidation of copper ions, and wherein the resulting ternary composite is analyzed for synergistic pseudocapacitance effects using cyclic voltammetry at scan rates from 5 to 100 mV/s.

In this embodiment, the electrochemical and mechanical properties of the PVA-KOH electrolyte and the ZnO//CuO nanocomposite are significantly enhanced through strategic doping, ensuring superior performance and stability in the final supercapacitor device. The first enhancement targets the gel polymer electrolyte. Following the complete dissolution and homogenization of PVA and KOH, the solution is cooled to ambient temperature to avoid thermal decomposition or premature reaction of dopants. At this stage, 1 weight percent lithium nitrate (LiNO₃) is introduced into the solution. The purpose of LiNO₃ addition is twofold: first, to introduce lithium ions which can coordinate with both the PVA chains and KOH, thereby forming transient ion-bridged polymer structures that facilitate faster ion hopping and reduce overall ionic resistance; and second, to slightly modulate the polymer's mechanical flexibility by disrupting local chain packing.

After doping, the ionic conductivity of the resulting electrolyte is evaluated using a dielectric analyzer fitted with blocking electrodes, which isolates ionic transport phenomena from electronic contributions. This ensures precise characterization of the electrolyte's ionic performance. Only those batches demonstrating ionic conductivity greater than 10⁻³ S/cm are considered suitable for use in supercapacitor assembly, as this threshold indicates sufficient mobility for high-rate charge/discharge operation. Furthermore, mechanical robustness is verified through tensile analysis, focusing on elongation at break. An elongation value exceeding 150% confirms that the gel can withstand mechanical deformation during electrode expansion and flexing, particularly in flexible or wearable applications.

Simultaneously, the performance of the ZnO//CuO nanocomposite is elevated through the incorporation of manganese dioxide (MnO₂), a well-known redox-active material with high pseudocapacitive potential. To maintain material integrity and prevent over-doping, MnO₂ is limited to a maximum of 3 weight percent. Rather than being added as a pre-formed nanopowder, MnO₂ is synthesized in situ within the reaction matrix. This is achieved by introducing 0.05 M potassium permanganate (KMnO₄) to the precursor metal salt solution after a 10-minute aging period. The delay in KMnO₄ addition is deliberate—it allows the metal precursors (Zn²⁺ and Cu²⁺) to partially hydrolyze and stabilize, preventing premature oxidation of Cu⁺ or uncontrolled precipitation.

The KMnO₄ undergoes reduction upon subsequent introduction of the plant extract, leading to the formation of uniformly dispersed MnO₂ nanoparticles within the evolving ZnO//CuO network. This co-synthesis ensures intimate mixing at the nanoscale, which is essential for maximizing interfacial contact and synergistic effects. The resulting ternary nanocomposite (ZnO—CuO—MnO₂) benefits from the combined electric double-layer capacitance of ZnO and CuO, along with the fast and reversible faradaic reactions of MnO₂. This synergy is validated through cyclic voltammetry (CV) studies performed at scan rates ranging from 5 to 100 mV/s. The CV curves typically reveal increased redox peak intensity and broadened voltammetric profiles, indicative of enhanced capacitive performance and superior rate capability.

This embodiment demonstrates a comprehensive materials engineering approach, combining electrolyte modification with strategic nanocomposite doping. By integrating LiNO₃ into the gel matrix and MnO₂ into the electrode architecture—both under carefully timed and controlled conditions—the system exhibits significantly improved ionic conductivity, mechanical flexibility, and pseudocapacitive energy storage. These enhancements ensure that the final supercapacitor device delivers high power density, excellent cycling stability, and robust performance under mechanical stress, aligning with the stringent requirements of next-generation flexible energy storage systems.

In an embodiment, the doctor blade casting of the AC-PVA slurry onto the stainless steel substrate is conducted on a temperature-controlled hot plate set at 323 K to induce immediate solvent evaporation at the interface and prevent binder migration, wherein the substrate is held in place with vacuum suction to prevent edge warping, and wherein after casting, the film is immediately passed through an IR pre-curing zone for 10 minutes before final drying to ensure binder penetration into micropores of the activated carbon matrix.

In this embodiment, the fabrication of the activated carbon (AC) electrode is optimized through a temperature-assisted doctor blade casting process that ensures uniform film morphology, prevents binder segregation, and enhances electrode-substrate adhesion—all of which are essential for consistent supercapacitor performance. The process begins by depositing the AC-PVA slurry onto a stainless steel substrate using a doctor blade system, but unlike conventional room-temperature casting, the substrate is placed atop a temperature-controlled hot plate maintained at 323 K. This elevated surface temperature plays a critical role in initiating immediate solvent evaporation at the interface between the slurry and the substrate, which not only helps to “lock” the bottom layer in place but also prevents the upward migration of the PVA binder during solvent evaporation—a phenomenon that can result in binder-rich surface layers and weakened mechanical integrity at the base.

To ensure dimensional stability and to maintain flatness during the casting process, the stainless steel substrate is held in place via vacuum suction. This prevents any movement or warping of the substrate edges, which can otherwise cause non-uniform film thickness or delamination during drying. The secure placement under vacuum also facilitates thermal uniformity across the substrate surface, ensuring consistent solvent evaporation kinetics and reducing the risk of film cracking or pore collapse.

Immediately after casting, the wet electrode film is transferred through an infrared (IR) pre-curing zone, where it is exposed to controlled IR radiation for 10 minutes. This pre-curing step accelerates solvent removal from the surface without causing thermal shock or binder degradation. More importantly, the gradual heating from IR exposure promotes binder migration into the internal microporous network of the activated carbon particles. This ensures that the PVA not only acts as a surface adhesive but also interpenetrates the porous structure, reinforcing the mechanical anchoring and electrochemical connectivity within the electrode matrix.

Following IR pre-curing, the electrode undergoes final drying and sintering steps, typically under vacuum or inert conditions, to remove any residual solvents and complete the polymeric network formation. The outcome is a mechanically robust, homogeneously cast electrode with well-distributed binder, improved internal cohesion, and optimal contact with the conductive stainless steel substrate. This embodiment therefore establishes a thermally mediated deposition protocol that addresses common challenges in carbon-based electrode fabrication—such as binder migration, delamination, and surface inhomogeneity—while enhancing the functional integration of the electrode with the current collector. The process directly contributes to better electrochemical cycling stability, consistent capacitance delivery, and enhanced overall device reliability in asymmetric supercapacitor architectures.

In an embodiment, during the synthesis of the precursor solution, the pH is adjusted to precisely 6.8 using 0.1 M NaOH solution added in 0.2 mL increments while continuously monitoring with a micro-pH electrode, wherein pH adjustment is done only after 15 minutes of salt dissolution to ensure complete ion dissociation, and wherein the pH-stabilized solution is allowed to equilibrate for an additional 10 minutes before introducing the plant extract to enable optimal bio-reduction kinetics and crystal nucleation control, and wherein the calcination of the dried precipitate is conducted within a dual-zone tubular furnace comprising a preheating zone maintained at 373 K and a primary calcination zone at 623 K, wherein the dried nanocomposite precursor is placed within a ceramic crucible lined with alumina wool and is first held in the preheating zone for 45 minutes to initiate organic phase degradation under a continuous flow of nitrogen gas at 150 mL/min, wherein the crucible is then gradually moved into the primary zone over 30 minutes using an automated translation stage to minimize thermal shock and agglomeration, and wherein the product is left to cool passively within the closed chamber to ambient temperature to preserve intergranular porosity and avoid structural collapse.

In this embodiment, precise control over pH and thermal treatment is employed to optimize the green synthesis and structural integrity of the ZnO//CuO nanocomposite used in asymmetric supercapacitor devices. The process begins with the preparation of the precursor solution, in which metal salts (e.g., zinc acetate and copper sulfate) are dissolved in deionized water. To ensure complete dissociation of the ionic species and achieve homogeneous mixing, the solution is allowed to sit undisturbed for 15 minutes after salt dissolution. This step is critical to prevent the formation of premature complexes and ensure a uniform ionic environment prior to any pH modification.

After ion dissociation, the pH of the solution is precisely adjusted to 6.8 using a 0.1 M NaOH solution, which is introduced incrementally in 0.2 mL aliquots. A micro-pH electrode continuously monitors the pH in real time, ensuring high-resolution control over the solution's chemical environment. The target pH of 6.8 is selected based on its optimal compatibility with the bio-reductive processes mediated by the plant extract, balancing hydrolysis kinetics of metal ions with the stability of the resulting hydroxide intermediates. Over-acidic or overly basic conditions can hinder the bio-reduction or lead to amorphous precipitates, whereas this carefully adjusted pH encourages controlled nucleation and uniform particle growth.

Once the desired pH is achieved, the solution is left to equilibrate for an additional 10 minutes. This equilibration period stabilizes the ionic environment, allowing transient hydrolysis products to stabilize before the introduction of the plant extract. Upon addition of the extract-typically rich in polyphenols, flavonoids, and other bio-reducing agents—the bio-reduction process initiates under highly controlled conditions, promoting the nucleation of metal oxide nanocrystals with well-defined morphology, surface functionality, and reduced defect-induced aggregation.

Following biosynthesis and drying of the precipitate, the nanocomposite is subjected to a meticulously staged calcination process within a dual-zone tubular furnace designed to minimize thermal stress and promote controlled crystallization. The dried precursor is placed in a ceramic crucible lined with alumina wool to provide insulation and protect against sudden temperature gradients. The crucible is initially introduced into a preheating zone maintained at 373 K, where it is held for 45 minutes. During this period, under a constant flow of nitrogen gas at 150 mL/min, residual plant organics and volatile impurities begin to decompose in a mild and gradual manner, preventing structural distortion and promoting uniform internal porosity.

After preheating, the crucible is mechanically translated into the primary calcination zone, which is maintained at 623 K. This transfer is performed slowly over a 30-minute interval using an automated translation stage, ensuring a gradual temperature gradient that mitigates the risk of thermal shock, nanoparticle fusion, or unwanted crystallite agglomeration. The 623 K zone completes the decomposition of remaining organic matter and facilitates the crystallization of the ZnO and CuO phases into nanocrystalline domains with well-defined grain boundaries.

Once the calcination is complete, the product is not quenched or rapidly cooled; rather, it is allowed to passively return to ambient temperature within the closed chamber. This slow, controlled cooling maintains the structural integrity of the nanocomposite, preserving intergranular porosity, minimizing crack formation, and avoiding collapse of the nanostructured network. This gentle cooling step is especially crucial for retaining the high surface area and defect-rich sites that contribute to the high pseudocapacitive performance of the final material.

Altogether, this embodiment provides an integrated synthesis approach that combines precise pH management, equilibrium stabilization, and spatially controlled thermal processing to yield a bio-synthesized ZnO//CuO nanocomposite with tailored morphology, enhanced crystallinity, and optimized porosity. These features directly contribute to superior ionic accessibility, efficient charge storage, and robust mechanical resilience in the final supercapacitor configuration.

In an embodiment, the PVA-KOH-coated ZnO//CuO electrodes are subjected to vibrational pre-compaction using a low-frequency orbital shaker at 10 Hz for 30 minutes immediately before assembly to enhance interfacial conformity, wherein the separator is manually trimmed under magnification to fit within ±0.1 mm tolerance of the electrode diameter, and wherein the assembly is enclosed in a PTFE compression cell and left under static pressure of 1.5 MPa for 12 hours to allow gel settling and ionic channel formation.

In this embodiment, precision mechanical conditioning and dimensional matching techniques are employed during the final assembly of the PVA-KOH-coated ZnO//CuO electrodes to ensure optimal interfacial conformity, minimal contact resistance, and consistent ionic accessibility within the asymmetric supercapacitor device. The process begins with a vibrational pre-compaction step, where the coated electrodes are placed on a low-frequency orbital shaker operating at 10 Hz for a duration of 30 minutes. This vibrational pre-treatment is performed immediately prior to device assembly and serves to improve the conformal contact between the PVA-KOH gel electrolyte and the nanostructured ZnO//CuO electrode surface. The low-frequency motion induces a micro-settling of the gel layer, promoting infiltration into nanoscale surface irregularities and enhancing physical adhesion at the electrode-electrolyte interface. This leads to the formation of a more intimate and continuous contact area, which is critical for efficient ion transport and minimizing interfacial impedance during operation.

Following the pre-compaction phase, the separator—typically a modified cellulose or ionomer-enhanced membrane—is carefully trimmed to match the precise dimensions of the electrode assembly. Using optical magnification tools such as a stereo microscope or magnifying loupe, the separator is manually cut to a diameter tolerance of ±0.1 mm relative to the electrodes. This tight tolerance ensures that the separator neither overlaps nor falls short of the electrode edges, thereby preventing electrolyte leakage, short-circuiting, or uneven pressure distribution during device sealing. Achieving such dimensional precision is essential for uniform ion diffusion pathways and electrochemical stability during high-rate charge-discharge cycling.

After trimming, the complete electrode-separator-electrode stack is enclosed within a polytetrafluoroethylene (PTFE) compression cell, selected for its chemical inertness, thermal stability, and mechanical resilience. The cell is subjected to static pressure of 1.5 MPa, applied uniformly across the stack, and held in this compressed state for 12 hours. This extended compaction period allows the PVA-KOH gel to settle fully into the interstitial voids between the electrodes and the separator, promoting robust gel-solid integration and ionic channel formation across the entire active area of the device. The pressure aids in eliminating microbubbles or trapped air pockets within the gel, which could otherwise contribute to uneven ionic conductivity or localized heating during electrochemical cycling.

In an embodiment, prior to centrifugation, the mixture containing the Moringa oleifera extract and metal precursors is subjected to dual-frequency sonication using a bath sonicator operating simultaneously at 40 kHz and 80 kHz for 20 minutes while maintaining the temperature at 313 K using an external cooling loop, wherein the alternating frequencies induce cavitation collapse that enhances nanoparticle nucleation by transient local heating and radical formation, wherein the sonicated mixture is allowed to age undisturbed for 1 hour to stabilize particle growth, and wherein the aged mixture is immediately centrifuged without dilution to prevent precipitation morphology changes, wherein the PVA-KOH gel electrolyte is applied to the electrodes via a sequential infiltration method involving three-stage drop casting, wherein 50 μL aliquots of the gel precursor are applied at 15-minute intervals to the surface of each electrode while held horizontally under controlled humidity of 40% RH and a temperature of 308 K, wherein each application is allowed to partially absorb and undergo pre-gelation before the next is applied, and wherein after the third application, the electrodes are cured under vacuum at 313 K for 4 hours to achieve layer-by-layer polymer densification and uniform ionic distribution across the active material interface.

In this embodiment, the synthesis and integration processes of the ZnO//CuO nanocomposite with PVA-KOH gel electrolyte are executed with high precision to enhance both nanoparticle formation and gel-electrolyte interfacial conformity. Initially, the mixture containing Moringa oleifera extract and the metal precursors is subjected to a dual-frequency ultrasonic treatment, where a bath sonicator simultaneously operates at 40 kHz and 80 kHz for 20 minutes. This simultaneous dual-frequency approach induces complex cavitation phenomena, where microbubbles collapse in both stable and transient regimes, generating localized hotspots of high temperature and pressure. These dynamic conditions promote the formation of reactive radicals and induce transient local heating, which in turn accelerates metal ion reduction and nanoparticle nucleation within the bio-reductive medium. The temperature of the sonication bath is actively maintained at 313 K through an external cooling loop to prevent bulk overheating, thereby maintaining optimal conditions for controlled nucleation while minimizing undesired thermal degradation of bioactive constituents.

Following sonication, the reaction mixture is allowed to age undisturbed for 1 hour, facilitating the stabilization and growth of nanocrystals under quiescent conditions. This aging step is essential to allow seed nuclei to grow into well-defined nanostructures with controlled morphology and size, benefiting from the previously generated radical-rich environment. To preserve the structural and morphological integrity of the resulting precipitates, the aged solution is subjected to immediate centrifugation without dilution. Avoiding dilution prevents alterations in ionic strength and pH, both of which could adversely affect the final particle morphology or induce re-dissolution or aggregation of newly formed nanoparticles.

In the subsequent step of electrode preparation, the PVA-KOH gel electrolyte is applied to the electrode surface using a sequential infiltration technique aimed at achieving precise control over gel distribution and penetration. This involves three-stage drop casting, where 50 μL aliquots of the gel precursor solution are applied at 15-minute intervals onto horizontally mounted electrodes under controlled environmental conditions specifically, a relative humidity of 40% and a temperature of 308 K. These conditions are finely balanced to slow down surface evaporation and allow the gel to partially absorb into the porous active material layer, initiating pre-gelation without prematurely solidifying. Each stage is timed to build the gel matrix gradually, promoting deeper infiltration into the active layer while minimizing bubble formation and surface irregularities.

After the third aliquot is applied and absorbed, the electrodes undergo a final curing process under vacuum at 313 K for 4 hours. This vacuum-assisted curing facilitates solvent removal and polymer densification, ensuring uniform ionic channel formation across the electrode-electrolyte interface. The vacuum environment also aids in extracting residual air pockets and moisture, which could otherwise disrupt continuity in the gel layer or interfere with electrochemical performance. Through the synergistic application of dual-frequency ultrasound-enhanced green synthesis, precise aging and separation control, and multi-stage gel application under controlled humidity, this embodiment achieves a highly uniform, defect-minimized, and ionically integrated electrode structure. These characteristics are vital for realizing high areal capacitance, fast charge-discharge behavior, and long-term operational durability in flexible, nanostructure-enhanced asymmetric supercapacitor devices.

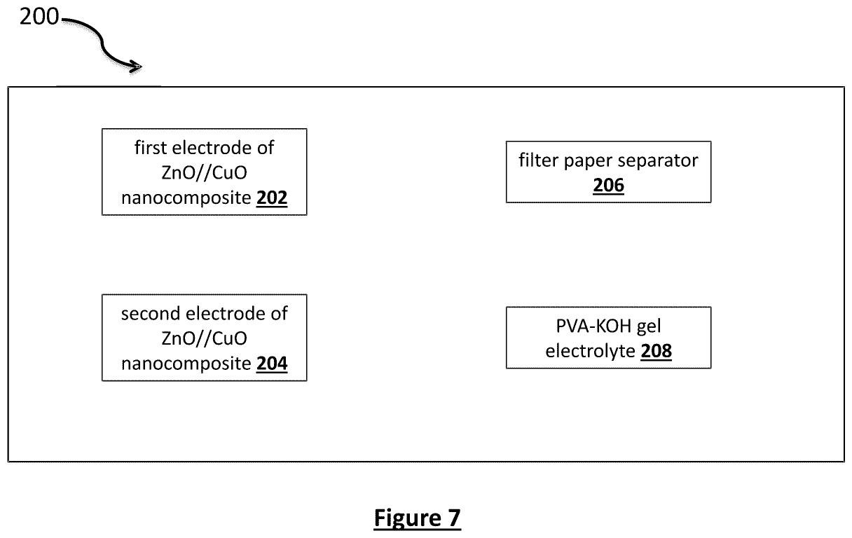

FIG. 7 illustrates a block diagram of a symmetric supercapacitor device in accordance with an embodiment of the present disclosure. The device (200) includes a first electrode (202) comprising a ZnO//CuO nanocomposite, wherein the first electrode (202) is a positive electrode.

The device further includes a second electrode (204) comprising a ZnO//CuO nanocomposite, wherein the second electrode (204) is a negative electrode.

The device further includes a separator (206) interposed between the first and second electrodes, wherein the separator is filter paper.

The device further includes a PVA-KOH gel electrolyte (208) in contact with the first and second electrodes and the separator, wherein at least a portion of the first and second electrodes are coated with the PVA-KOH gel electrolyte that has been dried, wherein the first and second electrodes are coated with the PVA-KOH gel electrolyte that has been dried at a temperature between about 303 K and about 308 K, wherein the first and second electrodes are pressed together for about 1 hour.

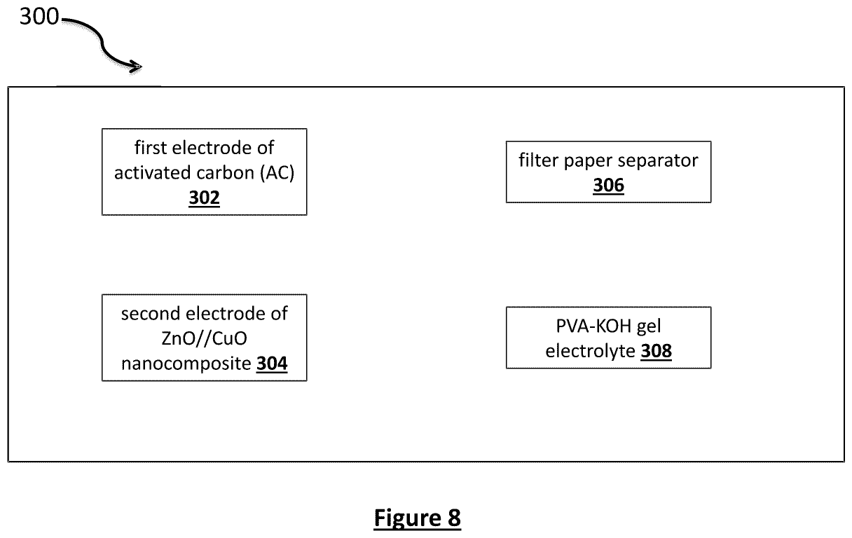

FIG. 8 illustrates a block diagram of an asymmetric supercapacitor device in accordance with an embodiment of the present disclosure. The device (300) includes a first electrode (302) comprising activated carbon (AC), wherein the first electrode(302) is a positive electrode.

The device further includes a second electrode (304) comprising a ZnO//CuO nanocomposite, wherein the second electrode (304) is a negative electrode.

The device further includes a separator (306) interposed between the first and second electrodes, wherein the separator (306) is filter paper.

The device further includes a PVA-KOH gel electrolyte (308) in contact with the first and second electrodes and the separator, wherein at least a portion of the first and second electrodes are coated with the PVA-KOH gel electrolyte that has been dried, wherein the first and second electrodes are coated with the PVA-KOH gel electrolyte that has been dried at a temperature between about 303 K and about 308 K, wherein the first and second electrodes are pressed together for about 1 hour.

The developed method synthesizes ZnO//CuO nanocomposites, comprising the steps of using Moringa oleifera leaf extract as a bio-reductant and stabilizing agent, and calcining the resulting precipitate at a temperature of 623 K to form the nanocomposite. The ZnO//CuO nanocomposite is characterized by a coral-like porous structure with a crystallite size of approximately 15-20 nm.

The developed invention fabricated a supercapacitor device comprising the ZnO//CuO nanocomposite as the electrode material, where the device can function in both symmetric and asymmetric configurations. The symmetric supercapacitor device having two electrodes is made from the ZnO//CuO nanocomposite, and the device exhibits a Cs of 819.4 F/g at a sweep rate of 2 mV/s. The asymmetric supercapacitor device having one electrode is made from the ZnO//CuO nanocomposite and the other from activated carbon, providing enhanced energy density and stability.

The developed method further fabricated a symmetric supercapacitor device, including the steps of forming thin-film electrodes from the ZnO//CuO nanocomposite and assembling them with a PVA-KOH gel electrolyte and a filter paper as a separator. The developed method also fabricated an asymmetric supercapacitor device, involving the assembly of a ZnO//CuO nanocomposite electrode and an activated carbon electrode with a PVA-KOH gel electrolyte and a filter paper separator. The ZnO//CuO nanocomposite electrode is characterized by a Cs of 94-99 F/g at a sweep rate of 100 mV/s and a high electrochemical stability over 6000 cycles.

The ZnO//CuO nanocomposite in dual-mode supercapacitor device exhibits pseudocapacitive behavior with distinct redox peaks during cyclic voltammetry analysis. The use of Moringa oleifera extract in the green synthesis of ZnO//CuO nanocomposites, where the extract acts as a reducing agent for zinc and copper ions, leading to the formation of a nanocomposite with superior electrochemical properties. The method enhances the specific capacitance of supercapacitor electrodes by incorporating a ZnO//CuO nanocomposite synthesized using a green approach. The ZnO//CuO nanocomposite is further characterized by the presence of well-defined ZnO and CuO peaks in X-ray diffraction patterns, confirming the formation of a composite phase. The addition of Moringa oleifera extract to metal precursors occurs dropwise under continuous stirring at a temperature of 100-150 rpm, forming a stable ZnO//CuO nanocomposite.

The method for improving the cycling stability of supercapacitor electrodes by using a ZnO//CuO nanocomposite, which retains over 87% of its initial capacitance after 6000 cycles. The ZnO//CuO nanocomposite electrode displays a small semicircle in the Nyquist plot at higher frequencies, indicating lower charge transfer resistance.

The ZnO//CuO nanocomposite in supercapacitor devices enables rapid ion diffusion and charge transfer, as evidenced by its performance at varying current densities. The ZnO//CuO nanocomposite synthesis is optimized to produce a ZnO//CuO nanocomposite with a crystallite size suitable for high-performance supercapacitor applications. The ZnO//CuO nanocomposite electrode is further characterized by FTIR analysis showing distinct peaks related to metal-oxygen bonds, confirmatory a successful incorporation of Cu into a ZnO matrix. The ZnO//CuO@AC device, as defined, which retains over 96% of its initial capacitance after 6000 cycles. The use of the ZnO//CuO nanocomposite in energy storage applications, wherein the composite's dual functionality simplifies device design, reduces material costs, and enhances overall efficiency.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for fabricating a dual-mode supercapacitor device based on synthesized ZnO//CuO nanocomposites, comprising:
a) preparing a precursor solution by dissolving zinc nitrate (Zn(NO₃)₂·6H₂O) and copper nitrate (Cu(NO₃)₂·3 H₂O) in 100 milliliters of sterile double-distilled water (DDW) to achieve a 1 M concentration;
b) separately adding 5 milliliters of a plant extract and the 50 milliliters of precursor solution dropwise into a reaction flask under stirring at 100-120 rpm to form a mixture and a precipitate, wherein the plant extract is prepared from Moringa oleifera leaf,
c) centrifuging the mixture to separate the precipitate from the supernatant, wherein the centrifugation is performed at about 8000 rpm for about 20 minutes, wherein the calcination is performed at a temperature of about 623 K for about 1 hour;
d) drying the separated precipitate in a hot air oven at approximately 323 K until fully dehydrated;
e) calcining the dried precipitate to obtain the ZnO//CuO nanocomposite; and
f) fabricating a dual-mode supercapacitor device based on based on synthesized ZnO//CuO nanocomposites, said dual-mode supercapacitor device comprising a first electrode and a second electrode, and wherein fabricating includes:
synthesizing a PVA-KOH gel electrolyte;
immersing the first electrode, the second electrode, and a separator in the PVA-KOH gel electrolyte;
assembling the supercapacitor device by pressing coated regions of the electrodes together with the separator interposed therebetween for 1 hour, and
wherein the synthesizing of the PVA-KOH electrolyte comprising the steps of:
dissolving 3 grams of polyvinyl alcohol (PVA) in 40 milliliters of deionized water (DDW);
heating the mixture to a temperature range of 348 K to 353 K while continuously stirring to form a PVA solution;
cooling the PVA solution to room temperature;
adding 10 milliliters of a 1 M potassium hydroxide (KOH) solution to the cooled PVA solution and stirring the mixture for 6 to 7 hours to form a solution; and
pouring the resulting solution into a Petri dish and allowing to air dry at room temperature to form an alkaline gel polymer electrolyte separator.

2. The method of claim 1, wherein Moringa oleifera leaf extract preparation, comprising the steps of:
cleaning fresh Moringa oleifera leaves using sterile double-distilled water (DDW) to remove any soil or impurities;
shade-drying the cleaned leaves for a period of 6 to 7 days to preserve the active metabolites;
grinding the dried leaves into a fine powder;
preparing an aqueous extract by mixing 5 grams of the powdered leaves with 50 milliliters of distilled water and thoroughly mixing;
heating the mixture at 353 K for 30 minutes to extract active compounds;
cooling the heated mixture at room temperature; and
filtering the cooled mixture to obtain a purified Moringa oleifera leaf extract thereby storing in sterile containers at 277 K.

3. The method of claim 1, wherein fabricating the dual-mode supercapacitor device comprises fabricating a symmetric supercapacitor device, comprising the steps of:
employing a first electrode comprising a ZnO//CuO nanocomposite and a second electrode comprising a ZnO//CuO nanocomposite, wherein the first electrode is a positive electrode and second electrode is a negative electrode;
deploying a separator between the first electrode and the second electrode, wherein the separator is filter paper;
preparing a PVA-KOH gel electrolyte and immersing the first electrode, the second electrode, and the separator in the PVA-KOH gel electrolyte for 10-15 seconds;
air-drying the first electrode, the second electrode, and the separator at 303 K for 1 hour;
coating the first electrode and the second electrode with the PVA-KOH gel electrolyte thereby drying in an electric oven at 303 K to 308 K for 6 to 8 hours to remove any adsorbed water; and
assembling the symmetric supercapacitor device by pressing the coated regions of the electrodes together with the separator interposed therebetween for 1 hour.

4. The method of claim 1, wherein fabricating the dual-mode supercapacitor device comprises fabricating an asymmetric supercapacitor device, comprising the steps of:
deploying a first electrode comprising activated carbon (AC) and a second electrode comprising a ZnO//CuO nanocomposite, wherein the first electrode is a positive electrode and second electrode is a negative electrode;
placing a separator between the first electrode and the second electrode, wherein the separator is filter paper;
immersing the first electrode, the second electrode, and the separator in a PVA-KOH gel electrolyte for 10 seconds;
air-drying the first electrode, the second electrode, and the separator at 303 K for 1 hour;
coating the first electrode and the second electrode with the PVA-KOH gel electrolyte thereby drying in an electric oven at 303 K to 308 K for 6 to 8 hours to remove any adsorbed moisture; and
assembling the asymmetric supercapacitor device by pressing the coated regions of the electrodes together with the separator interposed therebetween for 1 hour.

5. The method of claim 4, wherein the activated carbon (AC) electrode synthesis, comprising the steps of:
dissolving 1 gram of polyvinyl alcohol (PVA) in 10 milliliters of distilled water (DW);
heating and stirring the mixture at a temperature range of 343-353 K for 2 to 3 hours until the PVA is fully dissolved to obtain a polyvinyl alcohol (PVA) solution;
adding activated carbon (AC) to the PVA solution and stirring the AC-PVA mixture for an additional 2 hours at the same temperature range;
drying the resulting PVA-AC mixture in a desiccator to form a uniform slurry;
spreading the slurry onto a pre-cleaned stainless steel (SS) substrate using a doctor blade, wherein the SS substrate measures approximately 15 cm by 20 cm;
allowing the electrode samples to dry at room temperature for 4 hours; and
heat-treating the electrode samples in a muffle furnace at 353 K for 6 to 7 hours to complete the electrode fabrication process.

6. The method of claim 1, wherein the synthesized ZnO//CuO nanocomposite undergoes a post-calcination rehydration-assisted defect engineering process involving exposure to controlled humidity of 85% RH at 308 K for 4 hours inside a sealed polypropylene chamber to intentionally induce oxygen vacancies at grain boundaries, wherein the rehydrated nanocomposite is subsequently dried under vacuum at 0.1 Torr and 353 K for 6 hours to stabilize the induced lattice disorder, and wherein Raman spectroscopic analysis is performed to confirm the emergence of defect-induced modes at approximately 570 cm⁻¹ and 610 cm⁻¹ indicative of increased charge storage site density, and wherein the centrifuged precipitate is resuspended in ethanol-water mixture with a volumetric ratio of 3:1 for 30 minutes under magnetic stirring at 600 rpm to enhance removal of unbound phytoconstituents, wherein this washing step is followed by successive sedimentation-driven decantation cycles conducted three times, and wherein the final residue is vacuum filtered using a 0.45-micron PTFE membrane and oven dried at 323 K for 18 hours under low-light conditions to prevent photodegradation of surface-adsorbed polyphenolic moieties which contribute to electron transfer efficiency.

7. The method of claim 3, wherein both the first and second electrodes comprising ZnO//CuO nanocomposites are independently fabricated via dual solvent-phase slurry casting using N,N-Dimethylformamide and ethanol in a 3:2 ratio to adjust viscosity and optimize nanoparticle dispersion, wherein the slurry mixture includes 90 wt. % ZnO//CuO composite, 5 wt. % conductive carbon black, and 5 wt. % carboxymethyl cellulose binder, wherein the slurry is homogenized by triple-stage ultrasonication-pulse stirring-ultrasonication at 40 kHz, 300 rpm, and 40 kHz respectively, and wherein the film is cast using a doctor blade set at 150 μm clearance and vacuum dried at 333 K for 24 hours before mechanical pressing at 8 MPa to achieve uniform thickness and density, and wherein the separator is engineered by pre-soaking commercial cellulose filter paper in a 0.2 wt. % aqueous solution of poly(ethylene glycol) diglycidyl ether (PEGDGE) for 1 hour followed by thermal crosslinking at 363 K for 2 hours to enhance mechanical and ionic dimensional stability, wherein the crosslinked separator is then immersed in the PVA-KOH electrolyte for 30 minutes and gently blotted using a nitrogen stream, and wherein the resulting ionomer-enhanced separator exhibits a dimensional shrinkage rate below 1% after 100 thermal cycles between 298 K and 373 K, verified by in situ optical profilometry.

8. The method of claim 1, wherein the PVA-KOH gel electrolyte is synthesized using a controlled-rate heating protocol wherein the temperature is increased in 1 K/min increments from 298 K to 353 K to avoid polymer chain breakage, wherein continuous mechanical stirring at 400 rpm is maintained using a Teflon-coated impeller to avoid vortex-induced gelation inconsistencies, wherein upon complete dissolution, the solution is subjected to vacuum degassing at 0.01 Torr for 20 minutes to eliminate entrapped air bubbles, and wherein the resultant gel is cast in a level-grade silicone mold and allowed to dry in a nitrogen-flushed desiccator at 298 K for 72 hours to attain uniform gel polymerization with optimal ion mobility.

9. The method of claim 4, wherein the activated carbon electrode comprises a thermally pre-treated activated carbon precursor subjected to staged annealing at 473 K for 3 hours and 673 K for 2 hours under argon gas to modulate surface oxygen functional groups, wherein the pre-treated carbon is milled to <50 nm using a planetary ball mill at 500 rpm with zirconia media for 6 hours, and wherein the resultant powder is dispersed in a 0.5% PVA aqueous matrix and blade-cast onto acid-etched stainless steel foil pretreated with UV-ozone cleaning for 15 minutes to enhance surface energy and binding integrity before air-drying for 4 hours and sintering in a vacuum oven at 373 K, and wherein the asymmetric electrode pair comprising activated carbon and ZnO//CuO composite is thermally balanced via annealing both electrodes at 343 K for 2 hours in a single chamber with temperature uniformity of ±0.2 K, wherein the composite electrode is pre-charged to 0.8 V for 30 minutes in a three-electrode configuration using a potentiostat before final assembly to activate redox states, and wherein the assembled supercapacitor is allowed to equilibrate for 12 hours under static load-free conditions before any electrochemical characterization is conducted.

10. The method of claim 5, wherein the prepared AC-PVA slurry is subjected to colloidal stability analysis using dynamic light scattering to confirm zeta potential greater than ±30 mV indicating electrostatic repulsion between particles, wherein the slurry is then subjected to pH adjustment using dilute ammonia to reach a value of 10.5 prior to casting, and wherein the electrode coating process employs a three-pass tape casting method using a custom-built linear applicator with stepwise layering, ensuring total film thickness within ±5 μm across a 15 cm×20 cm substrate, with thermal ramping from 303 K to 353 K under argon flow to remove solvents without bubble nucleation, and wherein the muffle furnace used for thermal curing of the AC electrode includes a feedback-controlled PID loop with embedded IR thermocouples positioned directly beneath the sample stage to maintain real-time temperature deviation below ±0.1 K, wherein the sample is mounted on alumina crucibles to ensure thermal insulation from metallic heat sinks, and wherein the ramp rate during final 90 minutes of curing is reduced to 0.5 K/min to promote stable binder reflow without phase collapse of the AC matrix.

11. The method of claim 1, wherein the calcination of the dried ZnO//CuO precipitate is performed in a programmable box furnace with staged ramping—initial ramping at 2 K/min to 423 K with a hold of 1 hour, followed by 5 K/min to 623 K and a secondary hold for 1 hour—to enable progressive decomposition of phytochemical residues and formation of crystalline phases, wherein this is followed by controlled furnace cooling at 1 K/min to room temperature under static nitrogen atmosphere, and wherein thermogravimetric analysis of the intermediate steps is recorded to precisely match decomposition stages to reaction profiles for reproducibility across batches, and wherein the fabricated supercapacitor device is vacuum laminated using a thin thermoplastic polyurethane (TPU) encapsulation film under 200 Pa vacuum pressure and 393 K lamination temperature, wherein the film forms a barrier layer around the device to protect from moisture ingress and air oxidation, and wherein the laminated device is post-cured under a mechanical compression rig at 100 N load for 3 hours in a humidity-controlled environment at 25% RH to ensure electrode-electrolyte integration without layer delamination.

12. The method of claim 3, wherein electrode mass balancing is achieved by iterative coulometric titration using a constant-current charge-discharge profile at 0.5 A/g for 100 cycles on individual electrodes, wherein the mass ratio between positive and negative electrodes is calculated using extracted capacitance values and optimized to a range of 0.95-1.05 for symmetric pairing, and wherein final mass adjustment is done via micro-trimming with a precision blade under a stereomicroscope to maintain symmetrical capacitance response, and wherein the ZnO//CuO electrodes are coated on a graphene oxide-interfaced stainless steel substrate pre-functionalized with carboxyl groups via electrochemical anodization in 0.1 M oxalic acid at 15 V for 90 seconds, wherein the graphene oxide is spray-deposited at 60° C. using an ultrasonic nozzle with a flow rate of 0.25 mL/min and dried under vacuum, and wherein this surface-engineered electrode substrate is used to enhance adhesion, conductivity, and prevent interfacial delamination under long-term cycling conditions exceeding 10,000 charge-discharge cycles.

13. The method of claim 1, wherein real-time process monitoring is implemented using machine vision-based colorimetric feedback during gel electrolyte drying, wherein an RGB camera tracks the grayscale shift from 0.18 to 0.25 to detect gel phase transitions, wherein this image data is relayed to an embedded microcontroller that modulates a heated air blower to ensure spatially uniform evaporation, and wherein the entire process is conducted under a closed-loop feedback system for reproducibility across device batches, and wherein the final supercapacitor assembly undergoes a mechanical fatigue test simulating 5000 bending cycles at 30° curvature using a servo-driven mechanical flexor, wherein electrochemical impedance spectroscopy (EIS) is conducted before and after fatigue testing across 0.01 Hz to 100 kHz frequency range to quantify phase shift, equivalent series resistance (ESR), and charge transfer resistance variations, and wherein the device is deemed stable only if ESR variation remains within ±3% and capacitance retention exceeds 95% relative to pre-flexed state.

14. The method of claim 1, wherein after fabrication, the dual-mode supercapacitor is subjected to a two-step electrochemical activation protocol involving (i) potentiostatic hold at 1.5 V for 60 minutes in an environmental chamber maintained at 60% RH and 298 K to promote redox-active site preconditioning, and (ii) 500 galvanostatic charge-discharge cycles at 1 A/g current density to stabilize internal resistance, wherein real-time voltage drop across the device is monitored during each discharge cycle using a high-speed data acquisition system sampling at 1 kHz, and wherein activation is only considered complete once voltage sag rate between cycle 490 and 500 is below 0.01 mV/cycle.

15. The method of claim 4, wherein the ZnO//CuO nanocomposite used as the negative electrode in the asymmetric device is functionalized with nitrogen groups by exposing the post-calcined material to anhydrous ammonia gas at 473 K for 2 hours inside a tubular furnace, wherein the modified nanocomposite is immediately quenched to room temperature inside a nitrogen glove box to prevent re-oxidation, and wherein the nitrogen content is confirmed via XPS showing N1s peaks between 398-401 eV, corresponding to pyridinic and pyrrolic nitrogen, with a total nitrogen concentration not less than 3 at %, and wherein prior to final assembly, both the activated carbon and ZnO//CuO electrodes are exposed to UV-ozone for 5 minutes in a quartz chamber to remove surface contaminants and activate hydroxyl groups, wherein the surface energy is measured by contact angle goniometry and required to be less than 450 before proceeding, and wherein post-treatment electrodes are handled exclusively with non-particulate PTFE tweezers inside a nitrogen-filled glove box to maintain interfacial cleanliness and reproducibility.

16. The method of claim 1, wherein the PVA-KOH electrolyte is doped with 1 wt. % lithium nitrate (LiNO₃) added to the solution after cooling to room temperature but prior to final casting, wherein the addition of LiNO₃ is intended to form ion-bridged polymer chains to reduce ionic resistance, wherein ionic conductivity is measured using a dielectric analyzer with blocking electrodes, and wherein only electrolyte batches with ionic conductivity >10⁻³ S/cm and mechanical elongation at break >150% as tested by tensile analysis are used in final device assembly, and wherein the ZnO//CuO nanocomposite is mixed with a small amount of MnO₂ nanoparticles not exceeding 3 wt. %, and wherein said MnO₂ is synthesized in situ by adding 0.05 M potassium permanganate to the precursor solution before the plant extract is introduced, wherein this doping step is conducted only after 10 minutes of precursor aging to prevent premature oxidation of copper ions, and wherein the resulting ternary composite is analyzed for synergistic pseudocapacitance effects using cyclic voltammetry at scan rates from 5 to 100 mV/s.

17. The method of claim 5, wherein the doctor blade casting of the AC-PVA slurry onto the stainless steel substrate is conducted on a temperature-controlled hot plate set at 323 K to induce immediate solvent evaporation at the interface and prevent binder migration, wherein the substrate is held in place with vacuum suction to prevent edge warping, and wherein after casting, the film is immediately passed through an IR pre-curing zone for 10 minutes before final drying to ensure binder penetration into micropores of the activated carbon matrix.

18. The method of claim 1, wherein during the synthesis of the precursor solution, the pH is adjusted to precisely 6.8 using 0.1 M NaOH solution added in 0.2 mL increments while continuously monitoring with a micro-pH electrode, wherein pH adjustment is done only after 15 minutes of salt dissolution to ensure complete ion dissociation, and wherein the pH-stabilized solution is allowed to equilibrate for an additional 10 minutes before introducing the plant extract to enable optimal bio-reduction kinetics and crystal nucleation control, and wherein the calcination of the dried precipitate is conducted within a dual-zone tubular furnace comprising a preheating zone maintained at 373 K and a primary calcination zone at 623 K, wherein the dried nanocomposite precursor is placed within a ceramic crucible lined with alumina wool and is first held in the preheating zone for 45 minutes to initiate organic phase degradation under a continuous flow of nitrogen gas at 150 m/min, wherein the crucible is then gradually moved into the primary zone over 30 minutes using an automated translation stage to minimize thermal shock and agglomeration, and wherein the product is left to cool passively within the closed chamber to ambient temperature to preserve intergranular porosity and avoid structural collapse.

19. The method of claim 3, wherein the PVA-KOH-coated ZnO//CuO electrodes are subjected to vibrational pre-compaction using a low-frequency orbital shaker at 10 Hz for 30 minutes immediately before assembly to enhance interfacial conformity, wherein the separator is manually trimmed under magnification to fit within ±0.1 mm tolerance of the electrode diameter, and wherein the assembly is enclosed in a PTFE compression cell and left under static pressure of 1.5 MPa for 12 hours to allow gel settling and ionic channel formation.

20. The method of claim 1, wherein prior to centrifugation, the mixture containing the Moringa oleifera extract and metal precursors is subjected to dual-frequency sonication using a bath sonicator operating simultaneously at 40 kHz and 80 kHz for 20 minutes while maintaining the temperature at 313 K using an external cooling loop, wherein the alternating frequencies induce cavitation collapse that enhances nanoparticle nucleation by transient local heating and radical formation, wherein the sonicated mixture is allowed to age undisturbed for 1 hour to stabilize particle growth, and wherein the aged mixture is immediately centrifuged without dilution to prevent precipitation morphology changes, wherein the PVA-KOH gel electrolyte is applied to the electrodes via a sequential infiltration method involving three-stage drop casting, wherein 50 μL aliquots of the gel precursor are applied at 15-minute intervals to the surface of each electrode while held horizontally under controlled humidity of 40% RH and a temperature of 308 K, wherein each application is allowed to partially absorb and undergo pre-gelation before the next is applied, and wherein after the third application, the electrodes are cured under vacuum at 313 K for 4 hours to achieve layer-by-layer polymer densification and uniform ionic distribution across the active material interface.
